(19) United States
(12) Patent Application Publication
(10) Pub. No.: US 2021/0176758 A1
(43) Pub. Date: Jun. 10, 2021

(54) METHOD FOR TRANSMITTING AND RECEIVING DATA IN WIRELESS COMMUNICATION SYSTEM, AND DEVICE THEREFOR

(71) Applicant: LG Electronics Inc., Seoul (KR)

(72) Inventors: Duckhyun BAE, Seoul (KR); Hyunho LEE, Seoul (KR); Daesung HWANG, Seoul (KR); Yunjung Yl, Seoul (KR)

(21) Appl. No.: 17/045,275

(22) PCT Filed: Apr. 8, 2019
(86) PCT No.: PCT/KR2019/004134

§ 371 Date: Oct. 5, 2020

(30) Foreign Application Priority Data
Apr. 6, 2018 (KR) 10-2018-0040249
Apr. 6, 2018 (KR) 10-2018-0040260

(51) Int. Cl. H04W 72/04; H04L 1/00; H04L 1/18; H04W 72/10

(52) U.S. Cl. CPC H04W 72/0493; H04W 72/042; H04W 72/0446; H04W 72/10; H04L 1/1819; H04W 72/0413; H04L 1/0068

(57) ABSTRACT

The present specification provides a method for transmitting uplink data by a user equipment (UE) in a wireless communication system includes: sequentially receiving, from a base station (BS), first downlink control information (DCI) for allocation of a first resource and second DCI for allocation of a second resource; and when the first resource and a partial resource of the second resource overlap each other, transmitting, to the BS, the uplink data on the partial resource of the second resource or on the second resource, wherein the first DCI and the second DCI include at least one parameter for transmission of the uplink data.

### TECHNICAL FIELD

The present disclosure relates to a method for transmitting and receiving data in a wireless communication system, and more particularly, to a method for dynamically or semi-statically setting resources for user equipments (UEs) in a wireless communication system and a device supporting the same.

### BACKGROUND ART

A mobile communication system has been developed to provide a voice service while ensuring the activity of a user. However, the area of the mobile communication system has extended to a data service in addition to a voice. Due to the current explosive increase in traffic, there is a shortage of resources, and thus users demand a higher speed service. Accordingly, there is a need for a more advanced mobile communication system.

Requirements for a next-generation mobile communication system need to able to support the accommodation of explosive data traffic, a dramatic increase in the data rate per user, the accommodation of a significant increase in the number of connected devices, very low end-to-end latency, and high-energy efficiency. To this end, various technologies, such as dual connectivity, massive multiple input multiple output (MIMO), in-band full duplex, non-orthogonal multiple access (NOMA), super wideband support, and device networking, are researched.

### DISCLOSURE

### Technical Problem

The present disclosure proposes a method for dynamically or semi-statically allocating resources to a user equipment (UE) in a wireless communication system.

The present disclosure also proposes a method for allocating part of a resource already allocated to a UE to another UE requiring specific conditions.

The present disclosure also proposes a method for a UE to recognize a preempted resource through downlink control information (DCI) transmitted from a base station (BS) when an allocated resource is preempted by another UE.

The present disclosure also proposes a method for retransmitting untransmitted data when data cannot be transmitted due to a preempted resource.

Technical problems to be solved by the disclosure are not limited by the above-mentioned technical problems, and other technical problems which are not mentioned above may be clearly understood from the following description by those skilled in the art to which the disclosure pertains.

### Technical Solution

A method for transmitting uplink data by a user equipment (UE) in a wireless communication system includes: sequentially receiving, from a base station (BS), first downlink control information (DCI) for allocation of a first resource and second DCI for allocation of a second resource; and when the first resource and a partial resource of the second resource overlap each other, transmitting, to the BS, the uplink data on the partial resource of the second resource or on the second resource, wherein the first DCI and the second DCI include at least one parameter for transmission of the uplink data.

Furthermore, in the present disclosure, the first resource may include a resource region preempted for transmission of uplink data of another UE.

Furthermore, in the present disclosure, the preempted resource region may be a resource region for transmission or reception of data requiring delay lower than delay of the uplink data.

Furthermore, in the present disclosure, the preempted resource region may be dropped, punctured, rate-matched, or canceled.

Furthermore, in the present disclosure, the method may further include: being allocated, from the BS, a third resource region for re-transmission of data matched to the preempted resource region in the uplink data; and transmitting, to the BS, the data according to priority in the third resource region.

Furthermore, in the present disclosure, the priority may be determined based on at least one of uplink control information (UCI) type and/or service type of the data.

Furthermore, in the present disclosure, the uplink data may be transmitted based on the second DCI.

Furthermore, in the present disclosure, a transport block (TB) for transmission of the uplink data may be mapped to the partial resource or the second resource and transmitted.

Furthermore, in the present disclosure, an HARQ ID of the first DCI and an HARQ ID of the second DCI may be the same.

Furthermore, in the present disclosure, when a time obtained by subtracting a starting timing of the second resource from a starting timing of the first resource is smaller than a time obtained by adding a timing advance (TA) to a processing time of the second DCI, a resource from the starting timing of the first resource to the time obtained by adding the TA to the processing time of the second DCI may be used for transmission of the uplink data.

Furthermore, in the present disclosure, a size of a transport block based on the first DCI may be the same as a size of a transport block based on the second DCI.

A method for receiving uplink data by a base station (BS) in a wireless communication system includes: sequentially transmitting, to a user equipment (UE), first downlink control information (DCI) for allocation of a first resource and second DCI for allocation of a second resource; and when the first resource and a partial resource of the second resource overlap each other, receiving, from the UE, the uplink data on part of the second resource or on the second resource, wherein the first DCI and the second DCI include at least one parameter for transmission of the uplink data.

A user equipment of transmitting uplink data in a wireless communication system includes a radio frequency (RF) module for transmitting or receiving a wireless signal; and a processor functionally connected to the RF module, wherein the processor is configured to: sequentially receive, from a base station (BS), first downlink control information (DCI) for allocation of a first resource and second DCI for allocation of a second resource; and when the first resource and a partial resource of the second resource overlap each other, transmit, to the BS, the uplink data on part of the second resource or on the second resource, wherein the first DCI and the second DCI include at least one parameter for transmission of the uplink data.

### Advantageous Effects

According to an embodiment of the present disclosure, a specific terminal may use a resource of another terminal which has already been allocated or being transmitted in order to transmit urgent data (or traffic).

In addition, according to an embodiment of the present disclosure, when a resource allocated to another terminal is preempted for transmission of urgent data, the other terminal is informed that the resource has been preempted to thereby prevent a collision.

In addition, according to an embodiment of the present disclosure, when data cannot be transmitted in an initially allocated resource due to resource preemption for transmission of urgent data, the untransmitted data may be retransmitted through a resource allocated thereafter.

Effects which may be obtained from the disclosure are not limited by the above effects, and other effects that have not been mentioned may be clearly understood from the following description by those skilled in the art to which the disclosure pertains.

### DESCRIPTION OF DRAWINGS

The accompanying drawings, which are included to provide a further understanding of the disclosure and constitute a part of the detailed description, illustrate embodiments of the disclosure and together with the description serve to explain the principle of the disclosure.

FIG. 1 illustrates an example of an overall structure of an NR system to which a method proposed in the disclosure may be applied.

FIG. 2 illustrates the relation between an uplink frame and a downlink frame in a wireless communication system to which a method proposed in the disclosure may be applied.

FIG. 3 illustrates an example of a resource grid supported in a wireless communication system to which a method proposed in the disclosure may be applied.

FIG. 4 illustrates a structure of a self-contained subframe in a wireless communication system to which a method proposed in the present disclosure may be applied.

FIG. 5 illustrates a transceiver unit model in a wireless communication system to which a method proposed in the present disclosure may be applied.

FIG. 6 illustrates a hybrid beamforming structure in terms of a TXRU and a physical antenna in a wireless communication system to which a method proposed in the present disclosure may be applied.

FIG. 7 illustrates an example of a beam sweeping operation to which a method proposed in the present disclosure may be applied.

FIG. 8 illustrates an example of an antenna array to which a method proposed in the present disclosure may be applied.

FIG. 9 illustrates an example of a scheduling process of a terminal to which a method proposed in the present disclosure may be applied.

FIG. 10 illustrates an example of a method for retransmitting data in dynamic resource allocation proposed in the present disclosure.

FIG. 11 illustrates another example of a method for retransmitting data in dynamic resource allocation proposed in the present disclosure.

FIG. 12 illustrates another example of a method for retransmitting data in dynamic resource allocation proposed in the present disclosure.

FIG. 13 illustrates an example of a method for transmitting data when a terminal proposed in the present disclosure is preempted with a previously allocated resource.

FIG. 14 illustrates an example of a method performed by a base station to transmit data when a terminal proposed in the present disclosure is preempted with a previously allocated resource.

FIG. 15 is a block diagram of a wireless communication device to which methods proposed in the present disclosure may be applied.

FIG. 16 illustrates another example of a block diagram of a wireless communication device to which methods proposed in the present disclosure may be applied.

### MODE FOR INVENTION

Reference will now be made in detail to embodiments of the disclosure, examples of which are illustrated in the accompanying drawings. A detailed description to be disclosed below together with the accompanying drawing is to describe exemplary embodiments of the present disclosure and not to describe a unique embodiment for carrying out the present disclosure. The detailed description below includes details to provide a complete understanding of the present disclosure. However, those skilled in the art know that the present disclosure may be carried out without the details.

In some cases, in order to prevent a concept of the present disclosure from being ambiguous, known structures and devices may be omitted or illustrated in a block diagram format based on core functions of each structure and device.

In the present disclosure, a base station (BS) means a terminal node of a network directly performing communication with a terminal. In the present disclosure, specific operations described to be performed by the base station may be performed by an upper node of the base station, if necessary or desired. That is, it is obvious that in the network consisting of multiple network nodes including the base station, various operations performed for communication with the terminal may be performed by the base station or network nodes other than the base station. The ‘base station (BS)’ may be replaced with terms such as a fixed station, Node B, evolved-NodeB (eNB), a base transceiver system (BTS), an access point (AP), gNB (general NB), and the like. Further, a ‘terminal’ may be fixed or movable and may be replaced with terms such as user equipment (UE), a mobile station (MS), a user terminal (UT), a mobile subscriber station (MSS), a subscriber station (SS), an advanced mobile station (AMS), a wireless terminal (WT), a machine-type communication (MTC) device, a machine-to-machine (M2M) device, a device-to-device (D2D) device, and the like.

In the following, downlink (DL) means communication from the base station to the terminal, and uplink (UL) means communication from the terminal to the base station. In the downlink, a transmitter may be a part of the base station, and a receiver may be a part of the terminal. In the uplink, the transmitter may be a part of the terminal, and the receiver may be a part of the base station.

Specific terms used in the following description are provided to help the understanding of the present disclosure, and may be changed to other forms within the scope without departing from the technical spirit of the present disclosure.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology such as universal terrestrial radio access (UTRA) or CDMA2000. The TDMA may be implemented by radio technology such as global system for mobile communications (GSM)/general packet radio service (GPRS)/enhanced data rates for GSM evolution (EDGE). The OFDMA may be implemented as radio technology such as IEEE 802.11 (Wi-Fi), IEEE 802.16 (WiMAX), IEEE 802-20, E-UTRA (evolved UTRA), and the like. The UTRA is a part of a universal mobile telecommunication system (UMTS). 3rd generation partnership project (3GPP) long term evolution (LTE), as a part of an evolved UMTS (E-UMTS) using E-UTRA, adopts the OFDMA in the downlink and the SC-FDMA in the uplink. LTE-A (advanced) is the evolution of 3GPP LTE.

In addition, 5G NR (new radio) defines eMBB (enhanced mobile broadband), mMTC (massive machine type communications), URLLC (ultra-reliable and low latency communications), V2X (vehicle-to-everything) depending on a usage scenario.

Also, the 5G NR standard is classified into standalone (SA) and non-standalone (NSA) according to co-existence between the NR system and the LTE system.

In addition, 5G NR supports various subcarrier spacings and supports CP-OFDM in downlink and CP-OFDM and DFT-s-OFDM (SC-OFDM) in uplink.

Embodiments of the present disclosure may be supported by standard documents disclosed in at least one of IEEE 802, 3GPP, and 3GPP2 which are the wireless access systems. That is, steps or parts in the embodiments of the present disclosure which are not described to clearly show the technical spirit of the present disclosure may be supported by the standard documents. Further, all terms described in this document may be described by the standard document.

3GPP LTE/LTE-A/New RAT (NR) is primarily described for clear description, but technical features of the present disclosure are not limited thereto.

### Definition of Terms

eLTE eNB: The eLTE eNB is the evolution of eNB that supports connectivity to EPC and NGC.

gNB: A node which supports the NR as well as connectivity to NGC.

New RAN: A radio access network which supports either NR or E-UTRA or interfaces with the NGC.

Network slice: A network slice is a network created by the operator customized to provide an optimized solution for a specific market scenario which demands specific requirements with end-to-end scope.

Network function: A network function is a logical node within a network infrastructure that has well-defined external interfaces and well-defined functional behavior.

NG-C: A control plane interface used on NG2 reference points between new RAN and NGC.

NG-U: A user plane interface used on NG3 references points between new RAN and NGC.

Non-standalone NR: A deployment configuration where the gNB requires an LTE eNB as an anchor for control plane connectivity to EPC, or requires an eLTE eNB as an anchor for control plane connectivity to NGC.

Non-standalone E-UTRA: A deployment configuration where the eLTE eNB requires a gNB as an anchor for control plane connectivity to NGC.

User plane gateway: A termination point of NG-U interface.

Overview of System

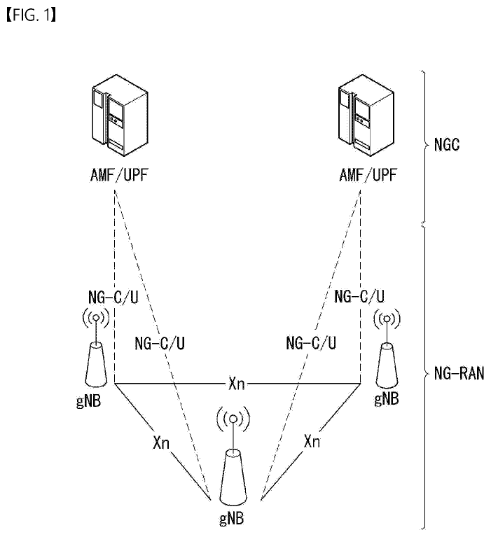

FIG. 1 illustrates an example of an overall structure of an NR system to which a method proposed in the disclosure may be applied.

Referring to FIG. 1, an NG-RAN is configured with an NG-RA user plane (new AS sublayer/PDCP/RLC/MAC/PHY) and gNBs which provide a control plane (RRC) protocol end for a user equipment (UE).

The gNBs are interconnected through an Xn interface.

The gNBs are also connected to an NGC through an NG interface.

More specifically the gNBs are connected to an access and mobility management function (AMF) through an N2 interface and to a user plane function (UPF) through an N3 interface.

NR (New Rat) Numerology and Frame Structure

In the NR system, multiple numerologies may be supported. The numerologies may be defied by subcarrier spacing and a CP (Cyclic Prefix) overhead. Spacing between the plurality of subcarriers may be derived by scaling basic subcarrier spacing into an integer N (or μ). In addition, although a very low subcarrier spacing is assumed not to be used at a very high subcarrier frequency, a numerology to be used may be selected independent of a frequency band.

In addition, in the NR system, a variety of frame structures according to the multiple numerologies may be supported.

Hereinafter, an orthogonal frequency division multiplexing (OFDM) numerology and a frame structure, which may be considered in the NR system, will be described.

A plurality of OFDM numerologies supported in the NR system may be defined as in Table 1.

TABLE 1

| μ | Δƒ = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |

Regarding a frame structure in the NR system, a size of various fields in the time domain is expressed as a multiple of a time unit of Tₛ=1/(Δfₘₐₓ·N_{f}). In this case, Δfₘₐₓ=480·10³, and N_{f}=4096. DL and UL transmission is configured as a radio frame having a section of T_{f}=(ΔfₘₐₓN_{f}/100)·Tₛ=10 ms. The radio frame is composed of ten subframes each having a section of T_{sf}=(ΔfₘₐₓN_{f}/1000)·Tₛ=1 ms. In this case, there may be a set of UL frames and a set of DL frames.

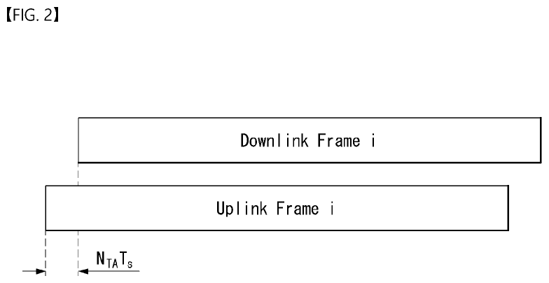

FIG. 2 illustrates the relation between an uplink frame and a downlink frame in a wireless communication system to which a method proposed in the disclosure may be applied.

As illustrated in FIG. 2, uplink frame number i for transmission from a user equipment (UE) shall start T_{TA}=N_{TA}Tₛ before the start of a corresponding downlink frame at the corresponding UE.

Regarding the numerology μ, slots are numbered in increasing order of

$${n}_{s}^{μ} ∈ \{ 0 , … , {N}_{subframe}^{slots , μ} - 1 \}$$

within a subframe and are numbered in increasing order of

$${n}_{s , f}^{μ} ∈ \{ 0 , … , {N}_{frame}^{slots , μ} - 1 \}$$

within a radio frame. One slot consists of consecutive OFDM symbols of N_{symb}^{μ}, and N_{symb}^{μ} is determined depending on a numerology used and slot configuration. The start of slots nₛ^{μ} in a subframe is aligned in time with the start of OFDM symbols nₛ^{μ}N_{symb}^{μ} in the same subframe.

Not all UEs are able to transmit and receive at the same time, and this means that not all OFDM symbols in a downlink slot or an uplink slot are available to be used.

Table 2 shows the number of OFDM symbols per slot for a normal CP in the numerology μ, and Table 3 shows the number of OFDM symbols per slot for an extended CP in the numerology μ.

TABLE 2
Slot configuration

| | 0 | | | 1 | | |
|---|---|---|---|---|---|---|
| μ | N_{symb}^{μ} | N_{frame}^{slots,μ} | N_{subframe}^{slots,μ} | N_{symb}^{μ} | N_{frame}^{slots,μ} | N_{subframe}^{slots,μ} |
| 0 | 14 | 10 | 1 | 7 | 20 | 2 |
| 1 | 14 | 20 | 2 | 7 | 40 | 4 |
| 2 | 14 | 40 | 4 | 7 | 80 | 8 |
| 3 | 14 | 80 | 8 | — | — | — |
| 4 | 14 | 160 | 16 | — | — | — |
| 5 | 14 | 320 | 32 | — | — | — |

TABLE 3
Slot configuration

| | 0 | | | 1 | | |
|---|---|---|---|---|---|---|
| μ | N_{symb}^{μ} | N_{frame}^{slots,μ} | N_{subframe}^{slots,μ} | N_{symb}^{μ} | N_{frame}^{slots,μ} | N_{subframe}^{slots,μ} |
| 0 | 12 | 10 | 1 | 6 | 20 | 2 |
| 1 | 12 | 20 | 2 | 6 | 40 | 4 |
| 2 | 12 | 40 | 4 | 6 | 80 | 8 |
| 3 | 12 | 80 | 8 | — | — | — |
| 4 | 12 | 160 | 16 | — | — | — |
| 5 | 12 | 320 | 32 | — | — | — |

NR Physical Resource

In relation to physical resources in the NR system, an antenna port, a resource grid, a resource element, a resource block, a carrier part, etc. May be considered.

Hereinafter, the above physical resources that may be considered in the NR system are described in more detail.

First, in relation to an antenna port, the antenna port is defined so that a channel over which a symbol on an antenna port is conveyed may be inferred from a channel over which another symbol on the same antenna port is conveyed. When large-scale properties of a channel over which a symbol on one antenna port is conveyed may be inferred from a channel over which a symbol on another antenna port is conveyed, the two antenna ports may be regarded as being in a quasi co-located or quasi co-location (QC/QCL) relation. In this case, the large-scale properties may include at least one of delay spread, Doppler spread, frequency shift, average received power, and received timing.

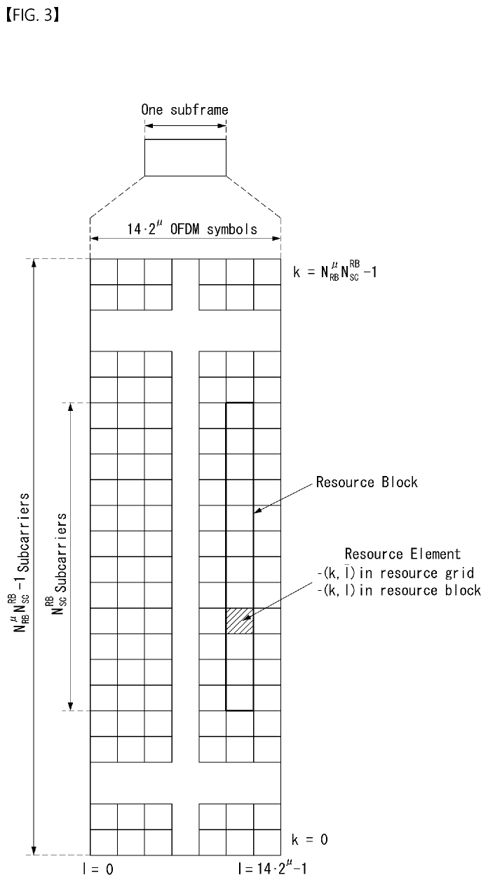

FIG. 3 illustrates an example of a resource grid supported in a wireless communication system to which a method proposed in the disclosure may be applied.

Referring to FIG. 3, a resource grid consists of N_{RB}^{μ}N_{sc}^{RB} subcarriers on a frequency domain, each subframe consisting of 14×2^{u} OFDM symbols, but the disclosure is not limited thereto.

In the NR system, a transmitted signal is described by one or more resource grids, consisting of N_{RB}^{μ}N_{sc}^{RB} subcarriers, and 2^{μ}N_{symb}^{(μ)} OFDM symbols, where N_{RB}^{μ}≤N_{RB}^{,μ}. N_{RB}^{max,μ} denotes a maximum transmission bandwidth and may change not only between numerologies but also between uplink and downlink.

In this case, as illustrated in FIG. 3, one resource grid may be configured per numerology μ and antenna port p.

Each element of the resource grid for the numerology μ and the antenna port p is called a resource element and is uniquely identified by an index pair (k,l̅) where k=0, . . . , N_{RB}^{μ}N_{sc}^{RB}−1 is an index on a frequency domain, and l̅=0, . . . , 2^{μ}N_{symb}^{(μ)}−1 refers to a location of a symbol in a subframe. The index pair (k,l) is used to refer to a resource element in a slot, where l=0, . . . , N_{symb}^{μ}−1.

The resource element (k,l̅) for the numerology μ and the antenna port p corresponds to a complex value a_{k,l̅}^{(p,μ)}. When there is no risk for confusion or when a specific antenna port or numerology is not specified, the indexes p and μ may be dropped, and as a result, the complex value may be a_{k,l̅}^{(p)} or a_{k,l̅}.

Further, a physical resource block is defined as N_{sc}^{RB}=12 consecutive subcarriers in the frequency domain. In the frequency domain, physical resource blocks may be numbered from 0 to N_{RB}^{μ}−1. At this point, a relationship between the physical resource block number n_{PRB} and the resource elements (k,l) may be given as in Equation 1.

$${n}_{PRB} = ⌊ \frac{k}{{N}_{sc}^{R B}} ⌋ \qquad [ Equation 1 ]$$

In addition, regarding a carrier part, a UE may be configured to receive or transmit the carrier part using only a subset of a resource grid. At this point, a set of resource blocks which the UE is configured to receive or transmit are numbered from 0 to N_{URB}^{μ}−1 in the frequency region.

Self-Contained Subframe Structure

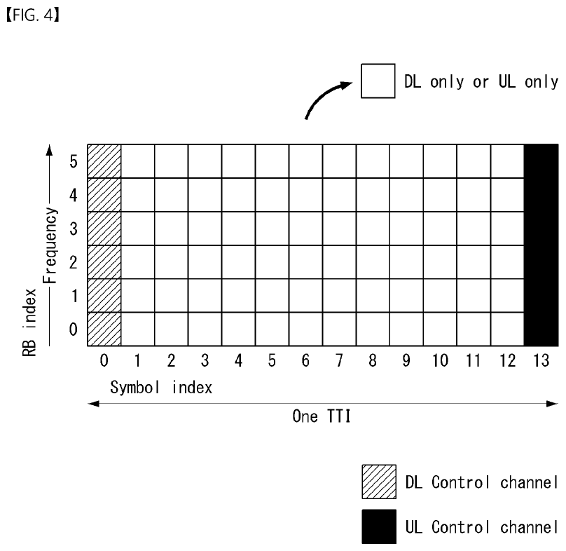

FIG. 4 illustrates a self-contained subframe structure in a wireless communication system to which the present disclosure may be applied.

In order to minimize data transmission latency in the TDD system, 5^{th} generation (5G) new RAT considers a self-contained subframe structure as shown in FIG. 4.

In FIG. 4, the shaded region (symbol index 0) indicates a downlink (DL) control region, and a black portion (symbol index 13) indicates an uplink (UL) control region. A region without a shaded mark may be used for DL data transmission or UL data transmission. The characteristic of this structure is that DL transmission and UL transmission are sequentially performed within one subframe, so that DL data may be transmitted and UL ACK/NACK may also be received within the subframe. As a result, a time taken for retransmitting data when a data transmission error occurs is reduced, and thus latency of final data transmission may be minimized.

In this self-contained subframe structure, a time gap is required for a BS and a UE to switch from a transmission mode to a reception mode or from the reception mode to the transmission mode. To this end, some OFDM symbols at a time point at which DL is switched to UL in the self-contained subframe structure are set as a guard period (GP).

Analog Beamforming

In millimeter wave (mmW), the wavelength is shortened, so it is possible to install multiple antenna elements in the same area. That is, in a 30 GHz band, the wavelength is 1 cm, and a total of 64 (8×8) antenna elements may be installed in a 2-dimensional array at 0.5 lambda (i.e., wavelength) intervals on a 4×4 (4 by 4) cm panel. Installation is possible. Therefore, in mmW, coverage may be increased by increasing a beamforming (BF) gain or throughput may be increased using multiple antenna elements.

In this case, if a transceiver unit (TXRU) is provided to enable transmission power and phase adjustment for each antenna element, it may be possible to independently perform beamforming for each frequency resource. However, installing TXRUs on all of the 100 antenna elements has a problem of deteriorated effectiveness in terms of price. Therefore, a method of mapping multiple antenna elements to one TXRU and adjusting a direction of a beam with an analog phase shifter is considered. This analog BF method has a disadvantage in that it cannot perform frequency selective BF because only one beam direction may be made in the entire band.

Hybrid BF having B TXRUs which is a number smaller than Q antenna elements may be considered as an intermediate form between digital BF and analog BF. In this case, although there is a difference depending on a connection method of the B TXRUs and Q antenna elements, directions of beams that may be simultaneously transmitted are limited to B or less.

Hereinafter, typical examples of a method for connecting TXRUs and antenna elements will be described with reference to the drawings.

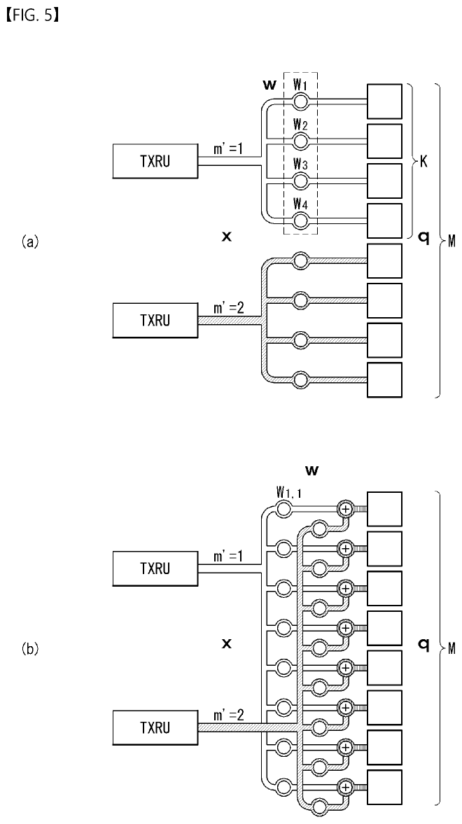

FIG. 5 illustrates a transceiver unit model in a wireless communication system to which the present disclosure may be applied.

A TXRU virtualization model represents a relationship between output signals of TXRUs and output signals of the antenna elements. The TXRU virtualization model may be classified into TXRU virtualization model option—1: sub-array partition model as shown in FIG. 5(a) and a TXRU virtualization model option—2: full-connection model as shown in FIG. 5(b) according to correlations between antenna elements and TXRUs.

Referring to FIG. 5(a), in the case of the sub-array partition model, antenna elements are divided into multiple antenna element groups, and each TXRU is connected to one of the groups. In this case, the antenna elements are connected to only one TXRU.

Referring to FIG. 5(b), in the case of the full-connection model, signals of multiple TXRUs are combined and transferred to a single antenna element (or array of antenna elements). That is, it shows a method in which the TXRUs are connected to all antenna elements. In this case, the antenna elements are connected to all TXRUs.

In FIG. 5, q denotes a transmission signal vector of M co-polarized antenna elements in one column. w denotes a wideband TXRU virtualization weight vector, and W denotes a phase vector multiplied by an analog phase shifter. That is, a direction of analog beamforming is determined by W. x is a signal vector of M TXRU TXRUs.

Here, mapping between the antenna ports and the TXRUs may be one-to-one (1-to-1) or one-to-many (1-to-many).

In FIG. 5, the TXRU-to-element mapping between the TXRUs and the antenna elements is merely an example, and the present disclosure is not limited thereto. The present disclosure may be applied equally to mapping between TXRUs and antenna elements that may be implemented in various other forms from a hardware perspective.

In addition, in the New RAT system, in the case of using multiple antennas, a hybrid beamforming technique combining digital beamforming and analog beamforming has emerged. In this case, analog beamforming (or radio frequency (RF) beamforming) refers to an operation of performing precoding (or combining) at an RF stage. In hybrid beamforming, a baseband stage and the RF stage each perform precoding (or combining), whereby performance close to digital beamforming may be obtained, while reducing the number of RF chains and D (digital)/A (analog) (or A/D) converters. For the sake of convenience, the hybrid beamforming structure may be represented by N transceiver units (TXRUs) and M physical antennas. Then, digital beamforming for the L data layers to be transmitted from a transmitter may be expressed as an N by L matrix, and the converted N digital signals are then converted to analog signals through the TXRUs and then analog beamforming expressed as an M by N matrix is applied.

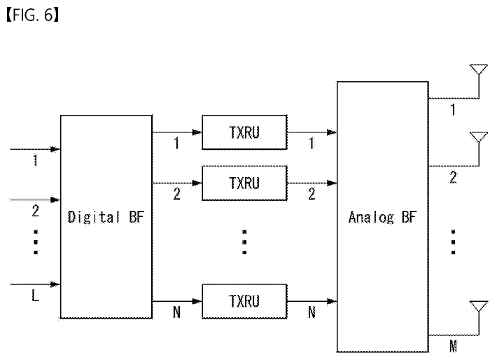

FIG. 6 illustrates a hybrid beamforming structure in terms of TXRUs and physical antennas in a wireless communication system to which the present disclosure may be applied.

FIG. 6 illustrates a case where the number of digital beams is L and the number of analog beams is N.

In the New RAT system, a direction for supporting more efficient beamforming to a user equipment (UE) located in a specific area is considered by designing a base station to change analog beamforming in units of symbols. Further, when specific N TXRUs and M RF antennas are defined as one antenna panel in FIG. 6, in the New RAT system, even a method of introducing a plurality of antenna panels to which applying independent hybrid beamforming may be applicable is considered.

Channel State Information (CSI) Feedback

In the 3GPP LTE/LTE-A system, a user equipment (UE) is defined to report channel state information (CSI) to a base station (BS or eNB).

CSI collectively refers to information that may indicate quality of a radio channel (or link) formed between a UE and an antenna port. For example, a rank indicator (RI), a precoding matrix indicator (PMI), and a channel quality indicator (CQI) correspond to the CSI.

Here, RI represents rank information of a channel, which refers to the number of streams that the UE receives through the same time-frequency resource. Since this value is dependently determined by long-term fading of a channel, it is fed back from the UE to the BS with a generally longer period than PMI and CQI. PMI is a value reflecting channel spatial characteristics and indicates a precoding index preferred by the UE based on a metric such as a signal-to-interference-plus-noise ratio (SINR). CQI is a value indicating strength of a channel and generally refers to a received SINR that may be obtained when the BS uses PMI.

In the 3GPP LTE/LTE-A system, the BS may set a plurality of CSI processes for the UE and may receive a report of CSI for each process. Here, the CSI process includes a CSI-RS for signal quality measurement from a base station and a CSI-interference measurement (CSI-IM) resource for interference measurement.

Reference Signal (RS) Virtualization

A PDSCH may be transmitted in only one analog beam direction at one time by analog beamforming in mmW. In this case, data transmission from the base station is possible only to a few UEs in the corresponding direction. Therefore, if necessary, by setting the analog beam direction to be different for each antenna port, data transmission to a plurality of UEs in various analog beam directions may be simultaneously performed.

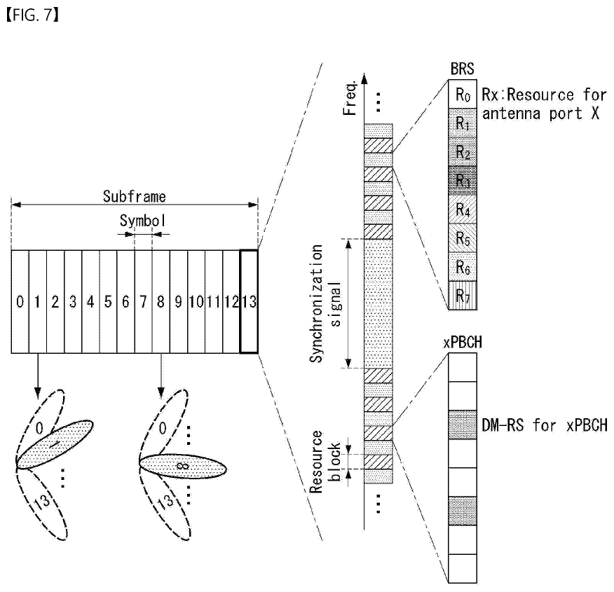

FIG. 7 illustrates an example of a beam sweeping operation to which the method proposed in the present disclosure may be applied.

As described in FIG. 6, when a BS uses a plurality of analog beams, analog beams advantageous for signal reception may be different for each UE, and thus, a beam sweeping operation in which a plurality of analog beams to be applied by the BS in a specific subframe is changed according to symbols so that all UEs may have a reception opportunity is considered for at least a synchronization signal, system information, paging, and the like.

FIG. 7 shows an example of a beam sweeping operation for a synchronization signal and system information in a downlink transmission process. In FIG. 7, a physical resource (or physical channel) in which system information is transmitted in a broadcasting manner in the New RAT is referred to as a physical broadcast channel (xPBCH).

Here, analog beams belonging to different antenna panels within one symbol may be simultaneously transmitted, and a method of adopting a beam reference signal (BRS) which is a reference signal transmitted by applying a single analog beam (corresponding to a specific antenna panel) as shown in FIG. 7 to measure a channel in accordance with an analog beam has been discussed.

The BRS may be defined for a plurality of antenna ports, and each antenna port of the BRS may correspond to a single analog beam.

In this case, unlike BRS, the synchronization signal or xPBCH may be transmitted by applying all analog beams in the analog beam group so that signals transmitted by arbitrary UEs may be properly received.

RRM Measurement

The LTE system supports RRM operations including power control, scheduling, cell search, cell reselection, handover, radio link or connection monitoring, and connection establish/re-establish.

In this case, a serving cell may request RRM measurement information, which is a measurement value for performing an RRM operation, from the UE.

For example, the UE may measure information such as cell search information, reference signal received power (RSRP), and reference signal received quality (RSRQ) for each cell and report it to the BS.

Specifically, in the LTE system, the UE receives ‘measConfig’ as a higher layer signal for RRM measurement from the serving cell. The UE measures RSRP or RSRQ according to ‘measConfig’.

The definition of RSRP, RSRQ and RSSI is as follows.
RSRP: RSRP may be defined as a linear average of a power contribution [W] of a resource element carrying a cell-specific reference signal within a considered measurement frequency bandwidth. A cell specific reference signal R0 may be used for RSRP determination. When it is reliably detected that the UE may be able to use R1, RSRP may be determined using R1 in addition to R0.

A reference point of the RSRP may be an antenna connector of the UE.

When receiver diversity is used by the UE, the reported value should not be lower than the corresponding RSRP of a certain individual diversity branch.
RSRQ: The reference signal reception quality (RSRQ) is defined as a ratio N×RSRP/(E-UTRA carrier RSSI), in which N is the number of RBs of the E-UTRA carrier RSSI measurement bandwidth. Measurement of numerator and denominator should be performed through the same set of resource blocks.

E-UTRA carrier received signal strength indicator (RSSI) is received by a block by the UE from a linear average of a total received power [W] measured only in OFDM symbols including a reference symbol for antenna port 0 and all the sources including N resources adjacent channel interference, thermal noise, and the like, in a measurement bandwidth.

When higher layer signaling indicates a specific subframe for performing RSRQ measurement, RSSI is measured for all OFDM symbols in the indicated subframe.

A reference point for RSRQ should be an antenna connector of the UE.

When receiver diversity is used by the UE, the reported value should not be lower than the corresponding RSRQ of a certain individual diversity branch.

RSSI: RSSI refers to a received broadband power including thermal noise and noise that occurs in the receiver within a bandwidth defined by a receiver pulse shaping filter.

The reference point for measuring RSSI should be an antenna connector of the UE. When receiver diversity is used by the UE, the reported value should not be lower than a corresponding UTRA carrier RSSI of a certain individual reception antenna branch.

According to the definition, in the case of an Intra-frequency measurement, the UE operating in the LTE system may be permitted to measure RSRP in a bandwidth corresponding to one of 6, 15, 25, 50, 75, 100 RB (resource block) through allowed measurement bandwidth transmitted in SIB5 in the case of inter-frequency measurement.

Alternatively, in the absence of the above IE, measurement may be performed in the frequency band of the entire downlink (DL) system by default. In this case, when the UE receives the allowed measurement bandwidth, the UE may regard the value as a maximum measurement bandwidth and freely measure the value of RSRP within the corresponding value.

However, if the serving cell transmits the IE defined as WB-RSRQ and the allowed measurement bandwidth is set to SORB or greater, the UE should calculate the RSRP value for the total allowed measurement bandwidth. Meanwhile, for RSSI, measurement may be performed in a frequency band of the receiver of the UE according to the definition of the RSSI bandwidth.

FIG. 8 illustrates an example of an antenna array to which the method proposed in the present disclosure may be applied.

A panel antenna array generalized in FIG. 8 may include Mg and Ng panels in a horizontal domain and a vertical domain, respectively.

Here, one panel includes M columns and N rows, respectively, and in FIG. 8, an X-pol antenna is assumed. Accordingly, a total number of antenna elements may be 2*M*N*Mg*Ng.

In the NR system, the BS may allocate time and/or frequency resources to the UE more dynamically and flexibly than the existing LTE system and allocate an individual bandwidth part (BWP) to the UE without limiting a frequency domain of the UE by a system bandwidth.

In addition, signaling that is allocated resources according to services with different quality of service (QoS) used by UEs may be different, and even if it is another UE or one UE, the system should prioritize traffic for a specific service in consideration of requirements between services in some cases.

For example, in order to transmit and receive data for a service requiring low latency and high reliability, the BS should be able to allocate resources to the UEs more dynamically than in the existing system.

Compared to the existing system, the NR/5G system may support various services at the same time, and one UE should be able to support various services at the same time.

In this case, if the corresponding QoS is classified only at a level of L2 or higher, it may not be suitable for a service that requires a very short delay.

In order to support such a service, the UE and the BS should be able to perform different operations according to QoS even in L1 according to QoS, and this requires a method in which the UE may distinguish QoS requirements of each packet.

For these operations, L1 also requires a method in which the UE may distinguish the QoS requirements of each packet. By performing such an operation, the UE may support data having a plurality of low QoS requirements and may process urgent data with a short interruption and minimum resources.

In the NR system, for dynamic resource sharing of downlink transmission, the BS may inform the UE about a preempted resource using group-common downlink control information (DCI), which is equally applied to a group including a plurality of UEs.

Specifically, in downlink transmission, the BS may puncture transmission of another UE to transmit data of a service that requires short delay and inform another UE about the puncturing or whether or not it is possible to puncture so that the UE may compensate for a damage by itself.

However, in uplink transmission, since transmission subjects are different UEs, additional considerations exist in performing the puncturing described in downlink transmission.

To this end, in the present disclosure, a method for managing an operation resource in uplink through a message for a punctured UE (hereinafter, a victim UE, vUE), additional signaling such as superposition transmission, or a transmission technique.

Compared to downlink resource sharing, uplink resource sharing is more important in the following aspects.

First, in the case of downlink, emergency data (e.g., ultra reliable and low latency communication (URLCC) traffic requiring high reliability and low latency, etc.) that needs to be transmitted quickly by increasing power by a network or by increasing resource use or the like may be given higher priority.

However, in the case of uplink, such an operation is limited due to limited power of the UE, and in particular, there is a case where it is difficult to avoid interference from a UE connected to another cell.

Accordingly, methods for effectively performing uplink multiplexing are very important, and in the case of a general URLLC use case, there are cases in which uplink traffic is more important (e.g., sensor data reporting, etc.).

Accordingly, the present disclosure proposes methods for effectively transmitting URLLC UL (Uplink).

In the present disclosure, UE multiplexing for physical uplink shared channel (PUSCH) transmission is described as an example, but the contents of the present disclosure may be generally applied to transmission used by the UE in the wireless communication system including the PDSCH, as well as transmission of the PUSCH using a set grant, physical uplink control channel (PUCCH) transmission by semi-static/flexible signaling, or uplink transmission in a random access procedure, in addition to a dynamic grant PUSCH transmission generally used by the UE.

In the NR system, a reference time unit assumed/used to transmit/receive a physical channel may vary according to an application field or a type of traffic. The reference time may be a basic unit for scheduling a specific physical channel, and the reference time unit may vary depending on the number of symbols configuring the corresponding scheduling unit and/or subcarrier spacing.

In an embodiment of the present disclosure, for convenience of description, description will be made based on a slot and a non-slot as a reference time unit.

The slot may be, for example, a basic unit of scheduling used for general data traffic (e.g., enhanced mobile broadband (eMBB)).

The non-slot may have a smaller time interval than slots on a time axis and may be a basic unit of scheduling used in more specific purpose traffic or communication methods (e.g., URLLC, unlicensed band, millimeter wave, etc.).

However, this is merely an embodiment, and it is apparent that the present disclosure may be applied even when the eMBB transmits and receives a physical channel based on a non-slot or when a URLLC or other communication scheme transmits and receives a physical channel based on a slot.

Although the present disclosure proposes a method of using an uplink multiplexing message for uplink multiplexing, various methods of signaling that a BS delivers to a UE for uplink multiplexing may be used and may have similar problems.

For example, TPC for power control, UL grant, which is a scheduling message, or new signaling may be used for multiplexing.

Therefore, it is obvious that the content of the present disclosure is not limited to a specific signaling method, and it is obvious that the whole or part of the invention may be applied to certain signaling when they are not mutually exclusive.

The method of preempting resources for URLLC transmission through UL grant has the following effects.

First, when the vUE in which uplink transmission is punctured should stop transmission in the allocated resource, a UL grant for uplink data that cannot be transmitted due to puncturing is separately required.

Therefore, signaling that schedules retransmission may be performed through one signaling by indicating that the resource already allocated to the vUE has been punctured through an indicator through a group common DCI and transmitting the grant again.

Also, compared to transmitting a separate DCI, retransmission of uplink data may be set faster.

Second, considering the effect of one URLLC packet on a plurality of downlink data in downlink, effective puncturing may not be performed due to capacity of control channel when scheduling is performed specifically for the UE through DCI.

Such a problem also exists in the case of uplink, but in uplink transmission, control channels may be distributed by using the advantage of a longer PDCCH to PUSCH time.

In addition, in the case of uplink transmission, the CBG indication may be used, but in the case of transmission, interpretation of the CBG+puncturing indicator may have to be different compared to the downlink.

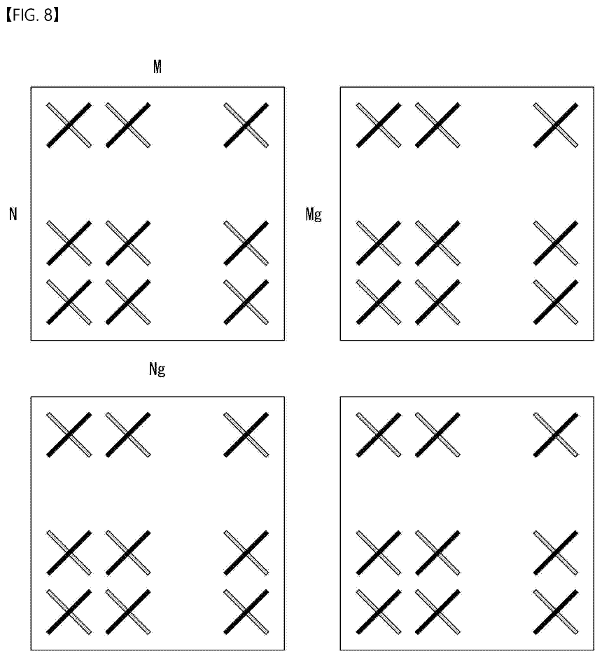

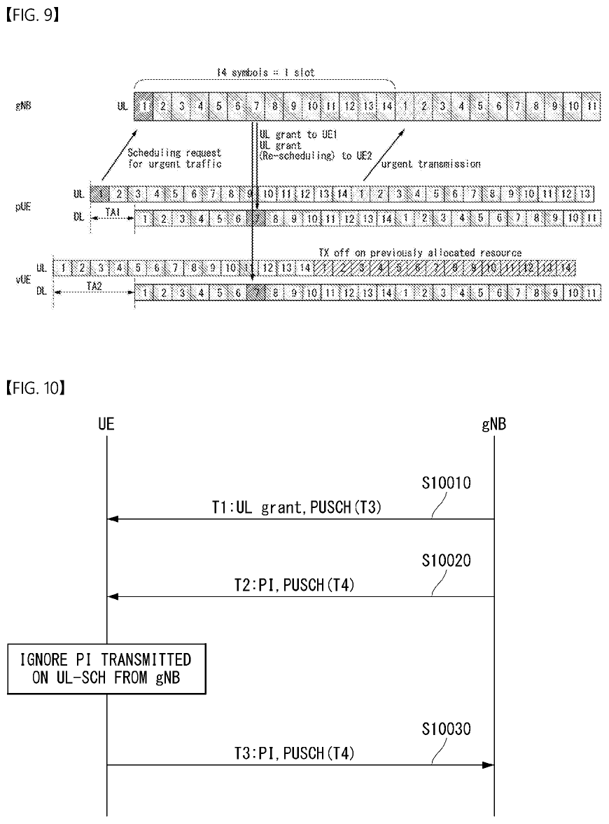

FIG. 9 illustrates an example of a scheduling process of a UE to which the method proposed in this disclosure may be applied.

Referring to FIG. 9, even when resources are allocated to the UE through UL grant, when specific data that should satisfy a specific condition occurs, the BS may allocate an already allocated resource to the UE that needs to transmit specific data.

Specifically, as shown in FIG. 9, when specific data for providing a service requiring low delay and/or high reliability occurs, the UE that desires urgent transmission of specific data (hereinafter, pUE, or UE 1) transmits a scheduling request (SR) to request resource allocation for transmission of specific data to the BS (or gNB).

If the BS receives the SR from UE 1 and may allocate a resource that satisfies the requirements of specific data, the BS may transmit a UL grant to UE 1 to allocate resources for transmission of specific data.

However, when there is no resource to be allocated to UE 1, the BS may cancel or delay a previously allocated uplink transmission of another UE (hereinafter, vUE or UE 2) for specific data transmission of UE 1.

That is, the BS may allocate a resource, which has already been allocated to the UE 2, to UE 1 so that the UE 1 may satisfy the specific condition and transmit specific data.

For example, the BS may transmit a UL grant to each of UE 1 and UE 2 and allocate resources necessary for emergency transmission of the specific data to UE 1, regardless of UE 2, and cancel the resource already allocated to the UE 2 for transmission of the UE 1.

That is, the BS may transmit a UL Grant to the UE 2 to drop, cancel, or postpone transmission of a transport block (TB) overlapped with the resource allocated to the UE 1.

In this case, the UL Grant transmitted by UE 2 may be a UL grant associated with the TB intended to be transmitted by the UE 2, and may be transmitted before the UE 2 transmits the TB.

The UL grant may be included to be transmitted in downlink control information (DCI) transmitted from the BS to the UE.

Before transmitting the TB in the resource allocated from the BS, the UE 2 that has received another UL grant for the same TB from the BS may recognize (or assume) that the resource for TB transmission is preempted by another UE.

In this case, the UE 2 may protect transmission of the UE 2 from preemption of UE 1 by transmitting uplink data to the BS by canceling all or part of transmission in the resources allocated from the BS or by lowering transmission power.

The UE 2 may retransmit a TB that has not been transmitted due to resource preemption in order to compensate for the influence due to resource preemption of the UE 1.

In other words, the UE 2 may transmit the untransmitted TB again later because it has failed to transmit the TB to be transmitted because it cannot use the already allocated resource due to the prior resource preemption of the UE 1.

Resource information (third resource, or third resource region) used for TB retransmission of UE 2 is clearly allocated by UL grant, or resource information used for retransmission of the TB to explicitly indicate the resource occupied due to previous resource preemption may be implicitly obtained from previous transmission scheduling information of the UE.

The UE 1 may retransmit uplink data by recognizing the occupied resource through the following procedure.

Step 1: When the UL grant is received through DCI or the like before transmitting the PUSCH of a specific TB, the UE may transmit the associated TB and the PUSCH through HARQ ID, NID and/or a transport block size (TBS) of the received UL grant.

However, if UE 2 has already received a UL grant (first UL grant) for allocation of resources for transmitting the specific TB, UE 2 may recognize that part or all of the resources allocated through a first UL grant has been preempted by another UE based on a secondly received UL grant (second UL grant).

Step 2: When UE 2 determines that the resource for transmission of a specific TB is not preempted by another UE, it transmits a PUSCH to the BS.

However, when recognizing that the resource for transmitting the specific TB through the second UL grant is a resource preempted by another UE, UE 2 may drop, rate-match, or puncture part or all of the resources allocated through the first UL grant.

That is, UE 2 may not use the resource, which is allocated to the UE 1 which is another UE by the BS among the allocated resources through the first UL grant, and thus preempted, for transmission of the specific TB.

Step 3: UE 2 may perform transmission of the specific TB that has not been transmitted due to resource preemption of UE 1 by using the resource allocation information of the second UL grant or the resource allocation information of the first UL grant.

That is, the specific TB affected by the resource preemption of UE 1 may be retransmitted to the BS based on the first UL grant or the second UL grant.

Here, in order to reduce the processing time, UE 2 may transmit the specific TB to the BS by using a processing result of the previously transmitted PUSCH transmission.

Since previously scheduled data has not been transmitted through the UL grant (or downlink scheduling DCI), a method for scheduling again may consider the followings.

First, when the device receives a new UL grant (second UL grant) before a time when the PUSCH (or PDSCH) scheduled by the previous UL grant (first UL grant) is transmitted, the device may cancel or puncture PUSCH (or PDSCH) transmission based on the first UL grant and transmit the PUSCH (or PDSCH) according to the second UL grant according to allocated resources.

Here, if the RA field of the second UL grant is NULL or if very few resources for TB transmission are allocated, a new resource for the TB transmission is not scheduled and the resource allocated by the first UL grant may be transmitted to be used for canceling or puncturing the resource allocated by the first UL grant.

Second, only when the second UL grant includes the resource allocated by the first UL grant and a HARQ ID, the second UL grant may be used for puncturing or canceling the resource allocated by the first UL grant.

Here, if the resource (first resource) allocated by the first UL grant and the resource (second resource) allocated by the second UL grant are not the same, canceling or puncturing of the resource may be performed only in a region where the first resource and the second resource overlap.

Hereinafter, each step will be described in detail.

### Embodiment 1—Indicator for Informing UE of Preempted Resource

The BS may transmit a UL scheduling signal, a UL grant in order to flexibly inform the UE that the resources already allocated to the UE are allocated to another UE.

That is, the BS may include an indicator (hereinafter, impacted resource indication (IRI)) indicating that the resource already allocated to UE 2 is preempted for transmission of emergency data requiring low delay and/or high reliability of UE 1 in the UL grant and transmit the same.

Specifically, the following may be considered in order to indicate a resource preempted by using the UL grant.

### Embodiment 1-1

In order to transmit the indicator indicating the preempted resource, UE-specific signaling may be used.

For example, the IRI may be transmitted through a UL grant for allocating resources to a UE. In this case, the UE may ignore DCI fields which are not associated with HARQ entities other than HARQ ID and NID included in the DCI for UL grant or which are not directly related to operations related to preemption of resources.

Specifically, the following method may be used to determine the preempted resource.

### Embodiment 1-1-1

The UE may recognize all of the previously scheduled transmission resources as preempted resources for a PUSCH which has not been transmitted yet and which has the same HARQ process as the HARQ entity indicated by the DCI.

In this case, resource preemption may be indicated through a separate field to distinguish it from the UL grant for retransmission of data due to the preempted resource or resource preemption may be indicated using a specific value (e.g., all values are 0 in RA Type 0, all values are ‘1’ in RA Type 1) such that zero resource allocation (RA) or all values are set to ‘1’ in frequency resource allocation.

In the case of using such a method, if a BWP index is included in the UL grant, the BWP index may be ignored.

If the BWP index is used, it may be regarded as an error if an operation for the BWP index is assumed and changed.

### Embodiment 1-1-2

The BS may directly indicate a preempted resource in a certain reference resource region using an additional DCI field.

That is, by adding a DCI field indicating a resource preempted by another UE and a reference resource region including the preempted resource region, the BS may clearly inform the UE of a position of the preempted resource.

In this case, a future time and/or frequency resource or portion or the entirety of a previously allocated transmission may be indicated as a reference resource.

For example, by using a flag having a size of n*k bits, K part of transmission of each n transmission may be represented as a preempted resource, or a previously allocated resource may be divided by a certain granularity and represented as k bits.

In this case, a reference resource may be specified using a DCI field that may be associated with the HARQ entity.

### Embodiment 1-1-3

A preempted resource may be determined based on time and/or frequency resource allocation information acquired by UL grant DCI, and a slot-aggregation factor may be ignored.

This embodiment may be used when only a part of resources having a small size are preempted by other UEs in the entire transmissions.

In this case, the time and/or frequency resource allocation information may be information related to a resource preempted by another UE or a resource that is not preempted.

When the time and/or frequency resource allocation information included in a UL grant DCI is information related to a resource preempted by another UE, the UE may puncture an overlap resource among resources allocated by the sequentially transmitted UL grant and recognize it as a resource preempted by another UE.

However, if the time and/or frequency resource allocation information included in the UL grant DCI is information related to a resource not preempted by another UE, the UE may recognize the overlapping resource among the resources allocated by the sequentially transmitted UL grant as an available resource and recognize a nonoverlapping resource as a resource preempted by another UE.

Here, the UE may remap the TB to the RA newly given by the second UL grant, or map the TB only to a portion in which the resource allocated by the first UL grant and the resource allocated by the second UL grant overlap in order to reuse baseband processing of the previous transmission.

Specifically, the UE, which has been allocated the first resource through the first UL grant from the BS, may recognize that all or part of the first resources are preempted by another UE for transmission of urgent data requiring low delay and/or high reliability through the second UL grant transmitted later from the BS.

For example, if the second UL grant includes an IRI or if the HARQ ID of the first UL grant and the HARQ ID of the second UL grant are the same, the UE may recognize that part or all of the first resource is preempted by another UE.

Alternatively, when part or all of the first resource region and the second resource region overlap, the UE may recognize that the overlapping or nonoverlapping part of the first resource region is preempted by another UE.

In this case, when the UE recognizes that the overlapping resource of the first resource and the second resource is preempted by another UE, the UE may transmit a TB in a resource that does not overlap the first resource on the second resource.

Alternatively, when the UE recognizes that the overlapping resource of the first resource and the second resource is not preempted by another UE, the UE may transmit a TB on the resource of the second resource overlapping the first resource or on the second resource.

In another embodiment of the present disclosure, if a frequency axis resource allocation acquired by the UE is zero RA, entire RA (entire resource allocation), or an undefined value (for example, all values of ‘1’), it may be recognized that the entire frequency domain indicated by the allocated time axis resource allocation information is preempted by another UE.

When the UE uses the time and/or frequency resource allocation obtained from signaling including IRI as information of the resource preempted by another UE, retransmission of the TB which has not been transmitted due to the preempted resource may be performed based on previously given resource allocation information.

In this case, SLIV and frequency RA may be values included in the previously given first DCI, and a slot offset and DCI reception timing may be a value based on the second DCI.

Alternatively, instead of the offset included in the second DCI, a preset value or a value given through higher layer signaling transmitted from the BS may be used.

By using UE-specific signaling as IRI signaling transmitted to the second UE, it is possible to fundamentally prevent for the first UE from erroneously receiving IRIR signaling, and since the RA required for the second UE to retransmit the TB which has not been transmitted due to preempted resource according to signaling design may be included in the IRI, signaling overhead may be reduced.

In the case of downlink, a CBG indicator may be used as an IRI. In the case of UL, the CBG indicator may also be used, but the interpretation of the CBG and puncturing indicator may differ from the downlink as follows.

### Embodiment 1-2-1

When IRI and CBG retransmission are received before transmission for the corresponding TB occurs, the UE may puncture (e.g., zero power) the CBG for which the indicator has received from a previous PUSCH UL grant and transmit the same.

In this case, it may be assumed that the UE preempted in resource ignores the new retransmission or has been set equally with the PUSCH before the frequency resource.

When indicated CBG and non-received CBG are mixed in a specific symbol, the UE may recognize that puncturing has not occurred. That is, the UE may assume zero power for a symbol including only the indicated CBG.

If the UE receives transmission of a timing that cannot be canceled after transmitting the TB, the UE may recognize that the indicated CBG has been punctured or interfered, and perform retransmission of TB only for the indicated CBG.

### Embodiment 1-2-2

When IRI and CBG retransmission are received before transmission of the corresponding TB occurs, the UE may drop all previous PUSCHs (i.e., determine whether to drop the previous PUSCH only by IRI) and perform retransmission on the indicated CBG through a configured resource.

### Embodiment 1-2-3

When IRI and CBG retransmission are received before transmission of the corresponding TB occurs, the CBG indicated in the previous PUSCH UL grant may be punctured (e.g., zero power) and the UE may terminate the previous PUSCH transmission of the TB.

Thereafter, the UE may perform retransmission (for punctured CBG) of the TB that has not been transmitted through a newly allocated resource from the BS.

### Embodiment 1-2-4

A UE operation may be defined using an additional DCI field (e.g., CBG IRI) together with the CBG indicator.

For example, when CBG_IRI is ‘1’, the UE may perform retransmission in the resource configured for the indicated CBG, and when it is ‘0’, the UE may perform retransmission for all CBGs.

The UE may transmit not only user data but also control information to the BS through uplink transmission. The uplink transmission may be different in resource, MCS, and data unit in use from the PUSCH, and since HARQ operation may not be performed, it may be difficult to define the transmission operation related to control information by parameters for PUSCH transmission included in DCI such as HARQ ID, NDI, MCS, TBS, etc.

For example, in the case of aperiodic CSI without UL-SCH transmitted through the PUSCH, a transmission method is similar to the PUSCH but a determination method such as TBS and MCS may be different, and since the UE does not perform the HARQ operation, a separate HARQ ID is also not allocated.

In UCI transmission using PUCCH, the UE and the BS use separate RA methods and do not perform HARQ operation either. Since such transmission also occupies a large proportion in uplink transmission, a method of utilizing these resources is required for dynamic resource sharing.

### Embodiment 1-3-1

The UE may indicate UCI transmission using PUCCH, transmission of a control channel, and the like by a UL grant, so that another UE may select a corresponding resource region.

Specifically, when a resource allocated for UCI transmission for PUSCCH is desired to be allocated to another UE, the BS may cancel SPS transmission in a corresponding slot through a UL grant including a zero-frequency RA or an undefined value (e.g., all 1's).

That is, when the UE receives the UL grant, if a frequency axis is not allocated along a time axis resource in a corresponding slot, the UE may recognize that the resource for the corresponding slot is canceled due to preemption of another UE.

In this case, the UE may cancel the SPS, PUCCH, grant-free resources, etc. scheduled in the canceled slot, and this may be performed by changing the UL resource to unknown with a group-common SFI.

In this case, the undefined value may refer to a case where an RA corresponding to the value does not exist.

As for the DCI used for the cancellation of such preemption resource, the DCI identification criterion or activation identification criterion used for aCSI or SP-CSI may be equally applied, or a part thereof may be applied.

### Embodiment 2—Identification of Preemptive Resource Through General UL Grant

As described above, it may be indicated that a resource allocated to a UE is preempted by another UE through UE-specific signaling, among others, a scheduling signal such as UL grant/DL assignment.

In such scheduling signaling, since the BS may directly deliver the time/frequency axis RA information required for transmission to the UE, resources for retransmission may be transmitted simultaneously with the IRI.

In addition, in the existing LTE system, when the UE receives an assignment/grant for one TB, the UE may recognize that DCI is not received for the same TB (TB with the same HARQ ID and/or NID) before reception/transmission of a TB for the allocated resource.

However, in NR, the UE may continuously perform DCI transmission/reception even for the same TB for the following reasons.
When assignment/grant is used as an IRI
In case of transmitting multiple DCIs for the same TB for PDCCH reliability
In case of receiving/transmitting transmissions for the same TB through different DCIs by separate transmission parameters, considering multiple access schemes such as NOMA.

In particular, in case where a UE-specific signaling such as assignment/grant is used to indicate a resource preempted by another UE and in case where a PDCCH is transmitted multiple times for different purposes at the same time, it is important for the UE whether the corresponding PDCCH is a PDCCH for IRI or whether it is transmitted for other purposes such as reliability.

Accordingly, it is necessary to identify whether the scheduling signaling received by the UE includes IRI or whether it means only a different purpose or simply new scheduling.

### Embodiment 2-1-1

When DCI (first DCI) transmitted for transmission of a TB and DCI (second DCI) for the same TB are received, UE may recognize the second DCI as a DCI indicating that the allocated resource is preempted by another UE.

Specifically, in case where transmission for TB A is previously allocated to the UE through the first DCI, if the second DCI for scheduling for the same TB (e.g., the same TBS, the same HARQ entity) is received from the BS, the UE may determine that the second DCI is a DCI indicating that the entirety of a portion of the resources allocated through the first DCI has been preempted by another UE.

In this case, the same HARQ entity may include the same HARQ ID and/or the same NDI.

### Embodiment 2-1-1-1

Here, when a timing at which the second DCI, which is scheduling for the same TB A, is received by the UE is t1 and a timing at which transmission of TB A through the first DCI is started is t2, if a processing time k in which t2+t1 or t2+t1-TA considering timing advance (TA) is greater than n1 which is a certain processing time/capability required for the UE to read DCI, the UE may determine the second DCI as a DCI indicating that the all or part of the resources are preempted by another UE.

That is, latency until the PUSCH is transmitted by the first DCI transmitted before the time when the second DCI is received from the BS is the DCI processing time of the UE+power adaptation latency (<n2 by not counting PUSCH encoding latency)).

Otherwise, the UE cannot process the DCI due to insufficient time to process the DCI, and thus may perform other operations.

### Embodiment 2-1-2

If a resource region allocated for transmission of TB A through the first DCI partially or entirely overlap a resource region allocated for transmission of TB A through the second DCI transmitted thereafter, the UE may determine the second DCI as a DCI indicating that the all or part of the resources are preempted by another UE.

Alternatively, even when part or all of the resources on the time axis overlap, the UE may determine the second DCI as a DCI indicating that the entirety of a portion of the resources are preempted by another UE.

### Embodiment 2-1-3

Similar to the SPS/configured grant scheme or CSI report without UL-SCH scheme, the UE may determine that the second DCI is a DCI indicating that all or part of the resources is preempted by another UE using a combination of a specific DCI field.

Specifically, DCI may be distinguished by setting some restrictions (e.g., restricting the use of some features such as a CQI trigger) in order to indicate preemption of resource.

For example, a feature (or field) used in the first DCI, which is a DCI for general resource allocation, may be restricted so that it is not used in the DCI for indicating resource preemption. In this case, when the UE receives the second DCI, which is a DCI that does not include such a feature (or field), the UE may recognize the received DCI as a DCI for indicating resource preemption by another UE.

In this case, the UE may not receive the first DCI, and upon receiving the second DCI, the UE may ignore or discard the second DCI in order to prevent malfunction.

### Embodiment 2-1-4

In the case of DCI for the same TB transmitted after K symbols/slots, the UE may recognize this DCI as a DCI for indicating resource preemption by another UE. This classification may be used to distinguish between repetitive transmission of the PDCCH for reliability and a preemptive resource indicator for canceling the previous scheduling.

For example, the UE may recognize the DCI for the same TB transmitted within 1 slot as repeated transmission of the PDCCH of the TB that was not transmitted due to resource preemption and the DCI transmitted later is a DCI for cancellation of preempted resource among previously allocated resources.

### Embodiment 2-1-5

A separate DCI format for indicating preemption resource may exist or only a specific DCI format may be used for indicating preemption resource.

### Embodiment 2-1-6

The UE may determine a received DCI as a DCI for indicating preemption resource based on additional information through an additional DCI field or bit number extension of the existing DCI field.

### Embodiment 2-1-7

Depending on whether slot-aggregation/repetition is set or by comparing the number of aggregated-slot/repetition K with K′(whether K is the same as, larger than or smaller than K′), the UE may determine whether the second DCI may be received when the first DCI is received.

For example, when repetitive transmission is configured, retransmitting all the data desired to be transmitted by the UE repeatedly is inefficient because already transmitted data may be retransmitted.

Accordingly, only when the UE performs repetitive transmission a number of times less than K′, the UE may recognize the additional DCI associated with the corresponding HARQ entity as a DCI for indicating resource preemption.

### Embodiment 2-1-8

In case where repetitive transmission of the PDCCH is configured, if the UE receives DCI according to the PDCCH repetition configuration, the UE may recognize that the DCI for indicating resource preemption can be received.

If the embodiments 1 to 2-1-8 described above are not mutually exclusive, multiple embodiments may be simultaneously applied. For example, by simultaneously applying the embodiments 2-1-4 and 2-1-5, only a specific DCI format received within a predetermined slot may be assumed as a DCI for indicating resource preemption.

The UE may operate differently depending on whether a resource preempted by another UE or a DCI for indicating such a resource is for downlink or uplink.

In addition, the UE may operate differently depending on whether a spectrum applied to the UE is paired (or unpaired).

For example, an applied embodiment among the embodiments described above may vary depending on whether it is FDD or TDD.

### Embodiment 3—Operation of UE Preempted in Resource

The UE (second UE) which has been preempted the allocated resource to another UE may acquire information related to preempted resource and/or information related to resource for retransmission through DCI for IRI which is an indicator indicating resource preemption.

In this case, the resource information may include information on partial resources or all resources.

That is, the IRI may include information related to part or all of the resources preempted by another UE (information of preempted resource) and information related to part or all of the resources for performing retransmission due to resource preemption (information of recovery (retransmission) resource for preempted transmission).

In this case, the operation of the UE may vary according to granularity of the corresponding information. For example, for the information of preempted resource, the operation of the UE may vary as follows according to whether the UE simply recognizes that all or part of the already allocated resources are preempted or whether it is assumed that a specific RE of the already allocated resources is preempted by another UE.

### Embodiment 3-1

When the UE determines that transmission for an already allocated resource (or transport block A) is preempted by another UE, the UE may drop, puncture, rate-match or cancel all or part of the previous transmission and retransmit TB A using scheduling information.

That is, when the UE determines that all or part of the resources already allocated by the BS are preempted through IRI, the UE may drop, puncture, rate-match, or cancel all or part of the allocated resources.

Thereafter, the UE may transmit a TB that has not been transmitted due to preemption of another UE to the BS based on information included in the IRI or scheduling information.

### Embodiment 3-2

When the UE recognizes, by the IRI, that a specific resource region R1 of transmission for already allocated TB A is not available or that a specific resource region R1 is unavailable and a specific resource region R2 is additionally available, the UE may drop, puncture, rate-match or cancel all or part of the previously allocated resources including R1 and retransmit TB A using scheduling information included in R2 or DCI.

In this case, the preempted resource area may be directly indicated. That is, the BS may clearly indicate a position of the preempted resource region to the UE through the IRI.

### Embodiment 3-2-1

In this case, it may be assumed that R1 is a resource preempted by another UE. For example, the UE may recognize the allocated R1 as a resource preempted for transmission of urgent data requiring low delay/high reliability by another UE, and may drop, puncture, rate match, or cancel grant resources of the second UL grant overlapping the allocated resource through the first UL grant

### Embodiment 3-2-2

The UE may assume R2 as an available resource. For example, the UE may assumed R2 allocated to the UE as an available resource and recognize a portion that does not overlap between R2 and R1 as a resource preempted by another UE, and drop, puncture, rate match, or cancel the resource.

Thereafter, the UE may be newly allocated a resource R3 from the BS and may map the untransmitted TB to the allocated resource R3 or map the TB to the R3 only in the resource in which R3 and R1 overlap and transmit the same to re-use baseband processing for transmission in R1.

In this case, the TBS may be set to be different in the previous and the current grant, but this may be applied only when the TBS is ignored or the TBS is not recalculated using the retransmission MCS.

### Embodiment 3-2-3

When resources allocated by DCI are used as R1 and R2, the previously given resource allocation may be reused for retransmission to TB A.

In this case, only RA information may be reused. For example, previously given values for SLIV and frequency RA may be used, and values based on a newly given DCI may be used for a slot offset and DCI reception timing.

Alternatively, SLIB and frequency RA may be based on a newly given DCI, and a previously given value may be used for DCI reception timing and slot offset.

The operation of the UE described above may vary depending on how the UE distinguishes IRI. For example, the UE may perform different operations according to a criterion for IRI described in the timing signaling method in which the IRI is transmitted and a resource information transferring method described in Embodiment 3-1.

### Embodiment 4—Resource Configuration for IRI in UE-Specified DCI

Scheduling information of the BS given to the UE in the NR may be limited to time-domain RA candidates considering the capability of the UE.

Therefore, an appropriate RA candidate may not exist in allocating a new resource excluding the resource preempted by UE 1 to UE 2 or indicating a resource region preempted by UE 1 using an existing RA information field.

Alternatively, because some RA information may be used to indicate the preempted resource itself, the following may be considered.

### Embodiment 4-1-1

The time offset for the time axis RA may be informed to the UE through a field configuring DCI or an additional field. The unit of the time offset may be a symbol or a slot.

In this case, a field configuring DCI may be a field having reserved bits such as CQI request, MCS, time or freq., RA information, and the like.

In such a method, when the UE does not receive the DCI (missing), a malfunction of the UE due to DCI for IRI may be prevented.

### Embodiment 4-1-2

Some RA information may be transmitted to the UE by using a predetermined value or by a BS through separate signaling. In this case, some of the information may include at least one of frequency axis information, SLIV, PUSCH mapping type, and slot offset.

For example, when the UE may identify the DCI for IRI, only the SLIV and DMRS mapping types are used in the time-domain RA information, and the offset value may not be used.

In this case, a predetermined value or a value given by higher layer signaling of the BS may be used may be used as a slot offset value indicating a new resource to be created.

### Embodiment 4-1-3

RA information candidates for the entire DCI format or a specific DCI format may be set regardless of decoding capability of the UE, and when the UE receives a DCI including information out of capability, the UE may perform best-offer or a separate operation.

The specific DCI format may be a DCI format separately configured for URLLC transmission requiring low delay/high reliability or a DCI format for fall-back operation.

### Embodiment 4-1-4

In the case of a rescheduling DIC for retransmitting data that has not been transmitted due to resource preemption, a K2 value may be set smaller than a N2 value corresponding to the PUSCH from the PDCCH by the UE.

In this case, the same TBS, modulation, and/or code rate as the previous transmission may be assumed.

Therefore, it is assumed that encoding delay is reduced and there is no new additional data (e.g., UCI piggyback, PHR piggyback). That is, it is assumed that scheduling for retransmission is possible for a limited case where K2 is smaller than N2, and a UL grant of the later transmitted DCI is regarded as a valid UL grant, the previous transmission is canceled and PUSCH may be transmitted according to a subsequent grant.

### Embodiment 5—Method Considering PUSCH Processing Time

In the method described in Embodiments 3-1-1 and 3-1-2, in case where the UE receives the re-scheduling grant of the second DCI for the TB that cannot be transmitted due to resource preemption at time T1, resource allocated by the first DCI for the same TB A exists at time T2 and a time point of PUSCH resource allocation included in the re-scheduling grant of the second DCI is defined as T3.

In this case, the following cases may exist according to the UL grant-to-PUSCH processing time N2 and/or timing advance TA of the UE.
Case 1: T2−T1<N2+TA
Case 2: T3−T1<N2+TA

If TA is already considered in N2, which is a processing time for PUSCH, in Cases 1 and 2, the value of TA may be 0 or may be ignored, and the value of TA may be a preset specific value (e.g., 0 or maximum TA value), rather than a TA value actually used by the UE.

In case of Case 1, it may be difficult or impossible for the UE to drop/puncture the start of transmission scheduled by the first DCI through the received re-scheduling grant.

Accordingly, the UE may perform the following operations.

### Embodiment 5-1-1

In the case of T2−T1<N2+TA, the UE may drop, puncture, rate-match, or cancel all or only part of the previous transmission resource (resource set by UL grant of the first DCI) configured after T1+N2 or T1+N2+TA and retransmit TB A that cannot be transmitted due to resource preemption by using scheduling information included in the second DCI or predetermined or based on higher layer signaling.

In this method, even if processing capability is insufficient, the preempted resource may be protected from UE 2 as much as possible.

In other words, even if UE 2 is re-allocated through DCI 2 due to the resource preempted by UE 1, UE 2 may start uplink transmission using the resource preempted by the UE 1 before the DCI 2 is processed by the UE 2.

That is, transmission of uplink data may be started before UE 2 recognizes that the resource already allocated through DCI 2 is preempted by the other UE.

UE 2 may drop, puncture, rate match, or cancel the preempted resource from the point when it is recognized that DCI 2 is processed and part or all of the already allocated resources have been preempted by the other UE.

### Embodiment 5-1-2

In case of T2−T1<N2+TA, the UE may maintain uplink transmission using previously allocated resources as it is and may perform transmission (or retransmission) for TB A using scheduling information.

This may be used when preempted resources may be multiplexed through a separate technique such as NOMA and power control.

In addition, through this, the BS may allocate resources to UE 2 for additional transmission for the same TB for reliability or the like.

This method has the effect of simplifying the operation of the UE.

In the case of Embodiment 5-1-2, the UE may be short of a UE processing time to perform new transmission using a re-scheduling grant.

In this case, the UE may shorten the processing time of DCI 2 by using the result of the baseband processing performed in DCI 1.

For example, UE 2 may perform only remapping at another position once again by using a modulated symbol of DCI previously transmitted and processed.

In this case, the PUSCH processing time may be N3(<N2).

### Embodiment 5-2

In case of T3−T1>N3+TA for processing time N3(=<N2), the UE may drop, puncture, and rate-match transmission scheduled by the first DCI and perform transmission based on the first DCI at T3.

Here, N3 may be a processing time required for performing only RE mapping on the corresponding information and reusing the existing baseband processing after UL grant is received.

This method may be used for shortening a processing time of the UE in the case of T3−T1<N2+TA which is Case 2.

Here, N3 or N3+TA may be considered as follows.

### Embodiment 5-2-1

N3 or N3+TA may be the same as T2−T1. That is, when T3 is later than T2, the operation of Embodiment 5-2 may be possibly performed.

### Embodiment 5-2-2

N3 or N3+TA may be the same as N2 or N2+TA, respectively. This has an effect such as reducing a processing burden and power consumption through the above method, even if the UE may process in time.

### Embodiment 5-2-3

As N3 or N3+TA, a value determined by higher layer signaling of the BS or a predetermined value may be used.

### Embodiment 5-2-4

N3 or N3+TA may be information included in the capability of the UE.

T3−T1, which is an RA value included in the rescheduling DCI (second DCI), may be limited according to capability of the UE, and the method described in Embodiment 4 may be considered for a more flexible operation.

### Embodiment 6—Method Considering PUSCH Processing Time

A size (TBS) of a resource allocated by the first DCI and that of a resource allocated by the second DCI may be different. Here, a TBS value calculated from a rescheduling grant (transmitted by the BS) and a TBS value of a previous transmission may be different.

In this case, even if the HARQ IDs and NDIs of the UL grants of the first DCI and the second DCI are the same (e.g., the first UL grant according to the 1 DCI and the second UL grant according to the second DCI are associated with the same TB, ambiguity may exist in performing retransmission of the TB.

Therefore, when the TBS value calculated from the re-scheduling grant through the second DCI and the TBS value in the previous transmission may be different as follows.

### Embodiment 6-1

The UE may ignore a rescheduled grant through the second DCI.

### Embodiment 6-2

The UE may assume that the grant rescheduled through the second DCI is a grant toggled from a new TB, i.e., NDI. This may be applied when there is no available resource having a sufficient size, and there is an effect that ambiguity may be reduced when DCI is missing.

### Embodiment 6-3

The UE may always set (or assume) the TBS value of the grant rescheduled through the second DCI to the same value as the previous TBS.

This may enable more flexible MCS selection and the MCS field to be used as separate information.

### Embodiment 6-4

If the TBS is different, the HARQ ID or the like are the same, and the NDI is not toggled, it may be regarded as an error or the UL grant of the second DCI may be used only for the purpose of a puncturing indicator.

### Embodiment 6-5

Rescheduling may be performed using the MCS field for retransmission of TB, and in a corresponding case, the UE may regard an initial UL grant missing case as an error. In case of using such a method, the TBS may follow the previous grant.

Even when resources are already allocated to the UE using Embodiments 1 to 6, resources may be flexibly allocated by allowing another UE to preempt the allocated resources according to data requirements.

In addition, in the case of using Embodiments 1 to 6, when a previously allocated uplink transmission of a certain UE is changed or canceled in order for a UE to use a previously allocated or transmitted resource of other transmission to transmit urgent traffic in a next-generation system, collision with the existing transmission and performance degradation of the existing transmission in the process may be minimized.

In particular, since the BS uses resource allocation overlapping the existing resource to indicate time/frequency location of the preempted resource of the UE, new transmission may be transmitted in a partial region of the existing resource regardless of HARQ process, which means that the existing resource allocation may be canceled without flushing a buffer of the existing HARQ process even in a limited time/frequency resource allocation granularity.

Through this, when the existing resource allocation information allocates a plurality of radio resources for one or a plurality of slots for the same HARQ process, transmission in unpreempted resources may be performed, thereby reducing control signaling overhead of the system. In addition, when retransmission for the corresponding HARQ process is required, a processing burden of the UE may be reduced.

Hereinafter, a method for solving a problem that occurs when UEs transmit uplink control information together with user data when an uplink resource used by using dynamic signaling is dynamically changed will be described.

When the UE supports the dynamic resource sharing of the uplink described in the previous Embodiments 1 to 6, the transmission resource of the UE may be dynamically changed.

For example, when the UE receives information related to the preemption of an already allocated resource by another UE from the BS through a specific signal, the UE may puncture/rate match or drop all of preempted resource or resource allocated for PUSCH transmission or perform rescheduling to move transmission to another PUSCH resource by receiving a new UL grant for the same TB before transmission completion for the PUSCH.

That is, the UE may recognize a UL grant or specific signaling received in a state where resources are already allocated for uplink transmission as an indicator indicating preemption resource and change a transmission time of the PUSCH scheduled to be transmitted in the preempted resource among resources allocated to the UE itself, or the like.

Here, transmission of the PUSCH maintains HARQ information, and thus ambiguity due to a change in transmission time may be removed.

However, in the case of the UCI transmitted on the PUSCH, since the UCI is closely related to the PUCCH resource at the time when the PUSCH is transmitted, the UCI to be transmitted may also vary according to the change in the transmission time of the PUSCH.

In this case, a method of compensating for UCI at a transmission time of a previous PUSCH that was not transmitted is required.

In addition, when the entire PUSCH resource is not canceled but partially canceled, part of the canceled resources may be a resource element (RE) through which UCI is transmitted.

In this case, the PUSCH resource excluding the canceled PUSCH resource may be transmitted, but the UCI may not be transmitted.

When the UCI is canceled and/or punctured, reliability of UCI transmission may be significantly degraded.

In consideration of this, when the PUSCH resource for transmitting UCI of a specific UE is preempted by PUSCH transmission of another UE, the following methods may be considered.

### Embodiment 7-1

Transmission of the PUSCH including UCI may be protected from resource preemption of another UE.

Here, even if the UE receives an indicator (hereinafter, a preemption indicator) indicating that the resource for the corresponding PUSCH transmission has been preempted by another UE from the BS, the UE may not apply it.

That is, when the UE transmits a PUSCH including UCI through the resource already allocated from the BS, even if the allocated resource is preempted by another UE, the UE may ignore this and transmits the PUSCH including UCI to the BS on the allocated resource.

Or, when the UE receives a preemption indicator from the BS, the UE may maintain the previous transmission without assuming puncturing/rescheduling for a symbol in which UCI is transmitted and a symbol in which a DM-RS for corresponding UCI transmission is transmitted.

Alternatively, the UE may ignore preemption of resources by another UE only if a current budget is less than the processing time required to transmit the UCI on the PUSCH through another channel such as PUCCH, that is, if the UCI cannot be moved by the PUCCH.

Such a UCI is limited to a UCI that may be piggybacked and may be ignored in the case of a UCI transmitted through aperiodic CSI.

Specifically, rescheduling may be performed using the same HARQ-ID/NDI for periodic CSI/semi-persistent CSI piggybacked to the PUSCH, and in this case, transmission be delayed.

In other words, if there is a HARQ ID corresponding to SPS/grant-free resource or the like, the UE may perform rescheduling using the SPS/grant-free resource,

### Embodiment 7-2

When PUSCH transmission including UCI is canceled and/or punctured by the BS, the corresponding UCI transmission may be retransmission of canceled/punctured PUSCH transmission or carry over in the rescheduled resource, that is, subsequently transmitted again.

In this case, transmission of UCI on the retransmission resource may be ignored or may be selected with priority according to the type of UCI.

### Embodiment 7-3

When PUSCH transmission including UCI is canceled and/or punctured by the BS, the canceled/punctured UCI is transmitted on previously allocated PUCCH resources or piggybacked to PUSCH resources of another cell.

The above operation may be limitedly performed only when a time duration from a time point at which the rescheduling DCI is received to a transmission time of the UCI transmitted using the above operation is greater than a time for the UE to process the rescheduling DCI.

This is to satisfy the processing time required for the rescheduling DCI to perform PUCCH transmission or perform piggyback to another PUSCH.

As another example, when the resource of the UE is rescheduled, all data to be transmitted in PUSCH/PUCCH including UCI may be canceled and the presence or absence of UCI transmission may be determined according to a UL grant of the rescheduling.

This may be dropped according to the PUSCH/PUCCH in which UCI is canceled, but there is an effect of reducing problems such as ambiguity occurring in the DCI missing case.

FIG. 10 illustrates an example of a method for retransmitting data in dynamic resource allocation proposed in the present disclosure.

In FIG. 10, T1 to T4 may refer to a certain point in time.

Specifically, as shown in FIG. 10, at T1, the UE may be allocated a PUSCH transmission to be transmitted from the gNB at T3 (S10010).

Here, at T2, the UE may be allocated resources for retransmission available at T4 by a preemption indicator (PI) transmitted from the gNB (T1<T2<T3<T4) (S10020).

In this case, when UCI is transmitted together with PUSCH transmission at T3, the UE may perform PUSCH transmission by ignoring the PI transmitted on a UL-SCH (S10030).

This may be useful for PI using group common DCI, and UCI ambiguity may be reduced by ensuring that UCI to be transmitted at T3 is always transmitted at T3.

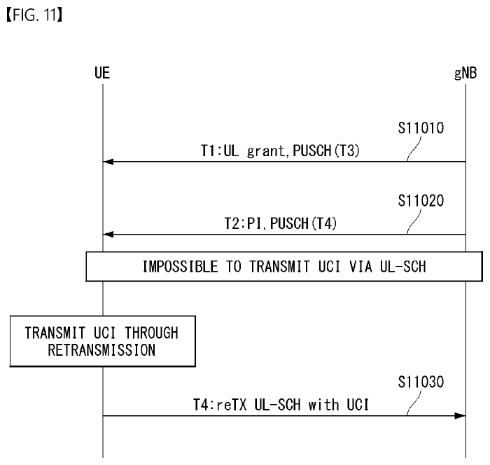

FIG. 11 illustrates another example of a method for retransmitting data in dynamic resource allocation proposed in the present disclosure.

Referring to FIG. 11, when the UE cannot transmit UCI, which is uplink control information, through UL-SCH on an allocated resource, the UE may retransmit UCI.

First, steps S11010 and S11020 are the same as steps S10010 and S10020 of FIG. 10, so a description thereof will be omitted.

Thereafter, when the UE cannot transmit UCI through the UL-SCH due to a resource preempted by another UE at T3, the UE may transmit UCI to be transmitted at T3 on the resource for retransmission allocated again by the PI (S11030).

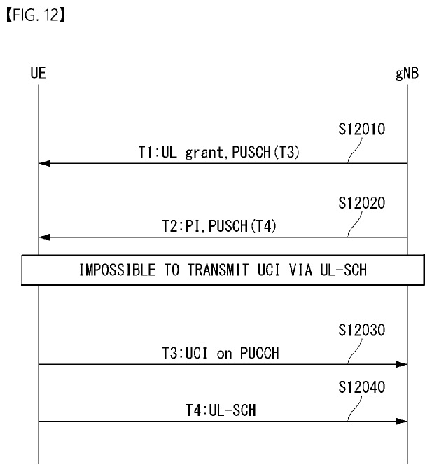

FIG. 12 illustrates another example of a method for retransmitting data in dynamic resource allocation proposed in the present disclosure.

Referring to FIG. 12, when the UE cannot transmit UCI, which is uplink control information, through UL-SCH on an allocated resource, UCI may be transmitted through an originally allocated PUCCH.

First, steps S12010 and S12020 are the same as steps S10010 and S10020 of FIG. 10, so a description thereof will be omitted.

Thereafter, when the UE cannot transmit UCI through UL-SCH due to resources preempted by another UE at T3, the UE may transmit UCI on the originally allocated PUCCH, without performing PUSCH transmission at T3, and perform UL-SCH of T3 again at T4 (S12030 and S12040).

The method shown in FIG. 1 may reduce UCI ambiguity by ensuring that UCI to be transmitted at T3 is always transmitted at T3, similar to the method described in FIG. 10, but application thereof may be limited according to PUCCH processing time and T3−T2 time.

### Embodiment 8—UCI Transmitted with PUSCH on Preempted Resource

This is a method of transmitting UCI on a PUSCH when the UE supports dynamic resource sharing and/or rescheduling.

### Embodiment 8-1

It may be assumed that the UE drops the UCI or the UCI is transmitted when transmission of a PUSCH resource including UCI is punctured, rate matched, dropped, and/or rescheduled by dynamic resource sharing.

That is, when a first resource allocated by the BS is preempted by another UE by dynamic resource sharing, the UE may puncture, rate match, drop, and/or reschedule the preempted resource.

Accordingly, it may be assumed that the UCI scheduled to be transmitted on the preempted resource is canceled in transmission or transmitted.

In this case, when UCI is not transmitted, the following operation may be performed.

For example, when the UE supports HARQ-ACK pending, the UE may pending the dropped HARQ-ACK so that the HARQ-ACK feedback that was not transmitted may be transmitted later.

### Embodiment 8-2

The UE may assume that transmission of a PUSCH resource including UCI is not punctured, rate matched, dropped, and/or rescheduled by dynamic resource sharing.

In this case, the UE may ignore the PI indicating resource preemption for transmission of the PUSCH resource including the UCI transmitted from the BS.

Specifically, this may be applied only to specific service(s) and/or specific UCI(s).

For example, the UE may ignore a PI for transmission of a PUSCH including HARQ-ACK feedback, a PUSCH including URLLC UCI, and/or a PUSCH resource including URLLC HARQ-ACK feedback.

### Embodiment 8-3

When transmission of a PUSCH resource including UCI is punctured, rate matched, dropped, and/or rescheduled by dynamic resource sharing, the corresponding UCI transmission may be retransmitted through a resource allocated from the BS.

### Embodiment 8-3-1

Specifically, Embodiment 8-3-1 may be applied only to specific service(s) and/or specific UCI(s).

For example, the UE may retransmit only HARQ-ACK feedback, URLLC UCI, or URLLC HARQ-ACK feedback to the BS through Embodiment 8-3-1.

This has an effect that higher PUSCH reliability may be obtained in recovery (re-)transmission by excluding information having a large size or time-sensitive information such as CSI.

### Embodiment 8-3-2

As another example of the present disclosure, when only part of the preset PUSCH transmission is punctured/rate matched and the UCI transmission is successfully performed, transmission of the corresponding UCI may be omitted from retransmission of UCI through resource allocation of the BS.

### Embodiment 8-3-3

DCI for retransmitting data that could not be transmitted due to resource preemption of another UE may trigger aperiodic CSI transmission, and the triggered CSI configuration may be a CSI configuration associated with a CSI included in the previously punctured, rate matched, dropped, and/or rescheduled PUSCH.

In this case, the UE may retransmit CSI information generated for previous PUSCH transmission when retransmitting data that was not transmitted due to resource preemption of another UE.

This may reduce processing time due to retransmission of data.

Meanwhile, when a previous UL grant is missing and/or a time for processing DCI is not enough, the UE ignores rescheduling DCI (retransmission DCI) and stops PUSCH transmission.

### Embodiment 8-3-4

DCI for retransmission due to resource preemption may trigger aperiodic CSI transmission, and the triggered CSI configuration may be a CSI configuration different from CSI included in the previously punctured, rate matched, dropped and/or rescheduled PUSCH.

Here, CSI information generated for previous PUSCH transmission is dropped.

That is, the UE assumes that a new CSI is calculated and transmitted from the BS according to the rescheduling DCI, and the corresponding calculation follows a general CSI processing procedure.

### Embodiment 8-3-5

If there is a UCI generated at a time of retransmission of data, the UE may select a specific UCI to be transmitted according to priority including the previous UCI.

For example, information such as HARQ-ACK may be transmitted as possible irrespective of the time of occurrence, and information such as CSI may be transmitted prior to the latest UCI.

The Embodiments 8-3-3 and 8-3-4 described above may be applied as separate embodiments regardless of how different UCIs are transmitted.

### Embodiment 8-4

When transmission of a PUSCH resource including UCI is punctured, rate matched, dropped, and/or rescheduled by dynamic resource sharing, the UCI may be transmitted on the originally allocated PUCCH.

### Embodiment 8-4-1

In particular, in Embodiment 8-4, when the PI is delivered as a new UL grant and dynamic resource sharing is performed through rescheduling for retransmission, the UE may consider a PUCCH processing time as well as the UL grant processing time to determine feasibility of the corresponding rescheduling.

Specifically, there may be a case in which a new UL grant delivered at the time T1 indicates a PUSCH resource at the time T2 as a resource preempted by another UE.

In this case, only when T2−T1 is greater than a time obtained by adding the PUCCH processing time to the UL grant processing time, the UE may regard the PI as feasible (“T2? T1>UL grant processing time+PUCCH processing time]” only).

### Embodiment 8-5

When transmission of a PUSCH resource including UCI is punctured, rate matched, dropped and/or rescheduled by dynamic resource sharing, the UCI may be transmitted on PUSCH resources allocated to other cells, and to this end, the BS may simultaneously transmit a PUSCH grant of other cells.

The PUSCH selected by this method may be selected according to a PUSCH selection rule for performing UCI piggyback, but if the selected PUSCH is preempted by another UE, a next PUSCH may be selected.

If there is no piggyback PUSCH in another cell, UCI may be transmitted on the originally allocated PUCCH.

If it is assumed that a PUSCH transmitted at a different timing in the same cell is selected and piggybacked, the following method may be considered for the UE to select another PUSCH.

### Embodiment 8-5-1

When a position of a start symbol of the existing PUSCH is S, the closest PUSCH having a start symbol of S or greater than S, among PUSCHs, may be selected by the UE.

Using this method, UCI transmission may be recovered the fastest.

### Embodiment 8-5-2

When the position of the start symbol of the existing PUSCH is S, a PUSCH having the largest resource among PUSCHs having a start symbol equal to or greater than S and smaller than S+K may be selected by the UE.

Using this method, performance degradation of the PUSCH may be minimized.

In this case, the K value may be received by the UE through higher layer signaling or may be a preset value.

### Embodiment 8-5-3

When the position of the start symbol of the existing PUSCH is S, the UE may use a PUSCH present in a cell having the smallest cell index among PUSCHs having a start symbol equal to or greater than S and smaller than S+K.

In this case, the K value may be received by the UE through higher layer signaling or may be a preset value.

### Embodiment 9—Priority of Each UCI Type

As described in Embodiments 8-1-1, 8-2-1, 8-3-5, and the like described above, when UCI occurring at the same time or at several times is transmitted in one PUSCH, a specific UCI may be dropped to secure reliability of UL-SCH transmission.

In this case, a priority rule that determines the drop of the UCI of a next priority will be described.

UCI to be transmitted first may be distinguished by the following criteria.

1. UCI (p.UCI) allocated to resource preempted by another UE vs. UCI (r.UCI) allocated to resource for retransmission

2. UCI types (n bit HARQ-ACK, CSI part 1, CSI part 2)

3. Service type (high.QoS vs. low.QoS)

Specifically, referring to priority of the UCI, first, priority may be determined by a UCI type.

Here, HARQ-ACK may have a higher priority than CSI (HARQ-ACK>CSI).

Next, priority may be determined according to resources allocated to preempted/recovery (re-)transmission.

Here, in the case of HARQ-ACK, the resource allocated to the preemption has a higher priority than the resource allocated to the recovery (re-)transmission, and in the case of CSI, the resource allocated to the recovery (re-)transmission may have a higher priority than resource allocated to the preemption.

(p. HARQ-ACK>r. HARQ-ACK>r. CSI>p.CSI)

Next, priority is determined according to QoS, and specifically, high.QoS may have a higher priority than low.Qos.

(high.p.HARQ-ACK>low.p.HARQ-ACK>high.r.HARQ-ACK>low.r.HARQ-ACK>high.r.CSI>low.r.CSI>high.p.CSI>low.p.CSI)

Meanwhile, a method of transmitting used UCI may be determined according to QoS of the UCI.

For example, when UCI is important, puncturing according to rescheduling DCI may be ignored.

In other words, according to importance of UCI, whether to drop or postpone UCI and whether to ignore implicit PI through rescheduling DCI, and the like may be determined.

It may be assumed that priority setting of UCI follows the highest QoS among the included UCIs.

When Embodiments 7 to 9 described above are not applied, the DL HARQ-ACK feedback of the UE cannot be transmitted to the BS or the HARQ-ACK assumption between the BS and the UE is varied, so that the HARQ-ACK feedback of another transmission may not be performed properly and unnecessary retransmission may occur.

According to Embodiments 7 to 9 described above, when a previously allocated uplink transmission of a certain UE is changed or canceled in order for a UE to use a previously allocated or transmitted resource of other transmission to transmit urgent traffic in a next-generation system, the uplink control information may be protected from this or retransmitted, thereby minimizing performance degradation of the existing transmission.

In addition, even if the uplink control information cannot be transmitted, the BS may be aware of such a situation in advance, thereby removing ambiguity in the operation between the BS and the UE.

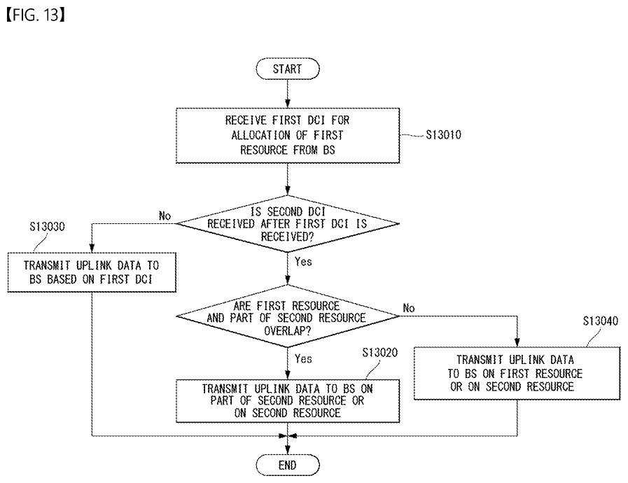

FIG. 13 illustrates an example of a method for transmitting data when a UE proposed in the present disclosure is preempted in a previously allocated resource.

Referring to FIG. 13, when a previously allocated resource is preempted for transmission of data for a specific service that requires low delay and/or high reliability of another UE, the UE may retransmit data through a re-allocated resource.

Specifically, the UE receives first downlink control information (DCI) for allocation of a first resource from the BS (S13010).

In this case, the first DCI may include a UL grant for allocation of the first resource and may include the HARQ entity described in Embodiments 1 to 9.

Thereafter, after receiving the first DCI, the UE may determine whether or not the second DCI has been sequentially received.

If the second DCI is not transmitted from the BS, the UE may transmit uplink data to the BS on the first resource allocated based on the first DCI (S13030).

However, when the second DCI is received after the reception of the first DCI, the UE may determine whether part or all of the first resource allocated by the first DCI and the second resource allocated by the UL grant of the second DCI overlap.

Here, the second DCI may include the HARQ entity in the same manner as the first DCI as described in Embodiments 1 to 9, and may include an indicator indicating whether part or all of the first resource are preempted for data transmission/reception of a specific service (e.g., URLLC, etc.) requiring low delay and/or high reliability.

In addition, the UE may recognize whether all or part of the first resource is preempted by another UE through the second DCI or the second resource, as in the method described in Embodiments 1 to 9.

For example, when part or all of the first resource and the second resource overlap, the UE may recognize that partial resource or the first resource has been preempted by another UE.

When the first resource and part or all of the second resource overlap, the uplink data may be transmitted to the BS on part of the second resource or on the second resource (S13020).

In this case, the first DCI and the second DCI may include at least one parameter for transmission of the uplink data as described in Embodiments 1 to 9.

Thereafter, the UE may retransmit part or all of the uplink data that has not been transmitted due to resource preemption by another UE to the BS through the method described in Embodiments 1 to 9.

However, when part or all of the first resource or the second resource do not overlap, the UE may determine that the first resource is not preempted by another UE, and may transmit uplink data on the first resource (S13040).

Through such a method, the effect that the BS is able to flexibly allocate resources to the UE according to the requirements required by data may be obtained.

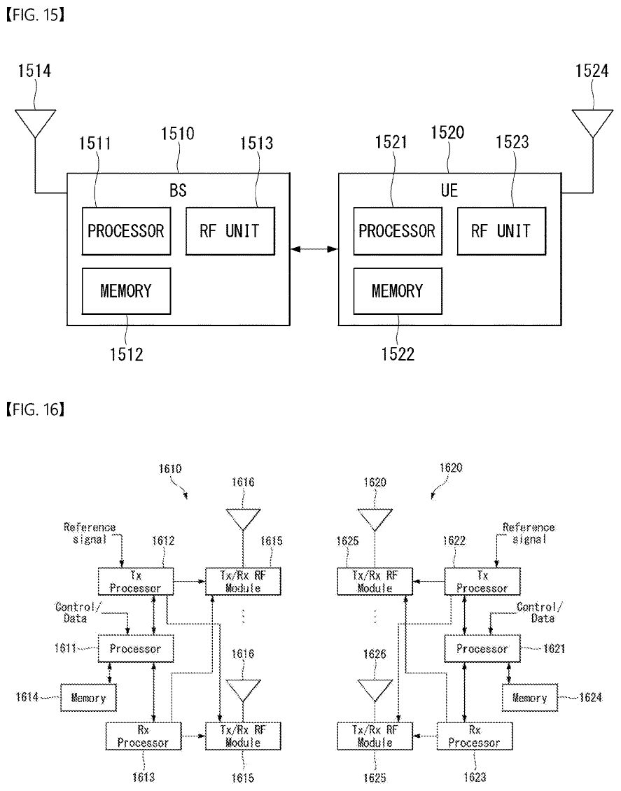

In this regard, the operation of the UE described above may be specifically implemented by the UE devices 1520 and 1620 shown in FIGS. 15 and 16 of the present disclosure. For example, the operation of the UE described above may be performed by the processors 1521 and 1621 and/or the RF units (or modules) 1523 and 1625.

Specifically, the processors 1521 and 1621 may control the UE to receive first downlink control information (DCI) for allocation of first resource from the BS through the RF units (or modules) 1523 and 1625.

In this case, the first DCI may include a UL grant for allocation of the first resource, and may include the HARQ entity described in Embodiments 1 to 9.

Thereafter, the processors 1521 and 1621 may determine whether the second DCI has been sequentially received after receiving the first DCI through the RF units (or modules) 1523 and 1625.

If the second DCI is not transmitted from the BS, the processors 1521 and 1621 may control to transmit uplink data on the first resource allocated based on the first DCI to the BS through the RF unit (or module) 1523 and 1625.

However, when the second DCI is received after the reception of the first DCI, the processors 1521 and 1621 may determine whether the first resource allocated by the first DCI and part or all of the second resource allocated by the UL grant of the second DCI overlap.

In this case, the second DCI may include the HARQ entity in the same manner as the first DCI as described in Embodiments 1 to 9, and include an indicator indicating whether part or all of the first resource are preempted for data transmission/reception of a specific service (e.g., URLLC, etc.) requiring low delay and/or high reliability.

In addition, the processors 1521 and 1621 may recognize whether all or part of the first resource is preempted by another UE through the second DCI or the second resource as described in Embodiments 1 to 9.

For example, when part or all of the first resource and the second resource overlap, the processors 1521 and 1621 may recognize that partial resource or the first resource is preempted by another UE.

When the first resource and part or all of the second resource overlap, the processors 1521 and 1621 may control to transmit uplink data to the BS on part of the second resource or on the second resource through the RF units (or modules) 1523 and 1625.

In this case, the first DCI and the second DCI may include at least one parameter for transmission of the uplink data as described in Embodiments 1 to 9.

Thereafter, the UE may retransmit part or all of the uplink data that have not been transmitted due to resource preemption by another UE to the BS through the method described in Embodiments 1 to 9.

However, when part or all of the first resource or the second resource do not overlap, the processors 1521 and 1621 may determine that the first resource is not preempted by another UE, and control to transmit uplink data on the first resource to the BS through the RF units (or modules) 1523 and 1625.

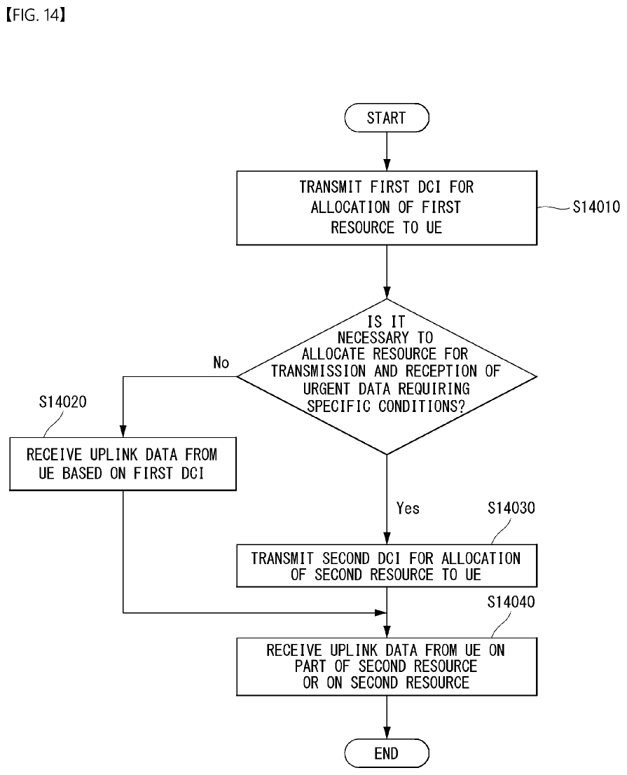

FIG. 14 illustrates an example of a method performed by a BS to transmit data when a UE proposed in the present disclosure is preempted in a previously allocated resource.

Referring to FIG. 14, when data requiring specific conditions is generated, the BS may satisfy the specific condition by re-allocating resource already allocated to the UE to another UE.

Specifically, the BS may transmit first downlink control information (DCI) for allocation of the first resource to the UE (S14010).

In this case, the first DCI may include a UL grant for allocation of the first resource and may include the HARQ entity described in Embodiments 1 to 9.

Thereafter, the BS may determine whether resource allocation to another UE is necessary for transmission and reception of emergency data requiring specific conditions (e.g., low delay and/or high reliability, etc.).

If there is no need for separate resource allocation to another UE, the first uplink data may be received on the first resource allocated to the UE based on the first DCI (S14020).

However, if separate resource allocation to another UE is required, the BS may allocate part or all of the first resource allocated to the UE to the other UE.

Thereafter, the BS may sequentially transmit the second DCI for allocation of the second resource to the UE after the first DCI transmission (S14030).

Here, the second DCI may include the HARQ entity in the same manner as the first DCI as described in Embodiments 1 to 9, and include an indicator indicating whether part or all of the first resource are preempted for data transmission/reception of a specific service (e.g., URLLC, etc.) requiring low delay and/or high reliability.

In addition, the BS may inform whether all or part of the first resource is preempted by another UE through the second DCI or the second resource as described in Embodiments 1 to 9.

For example, when part or all of the first resource and the second resource overlap, the UE may recognize that partial resource or the first resource is preempted by another UE.

When part or all of the first resource and the second resource overlap, the BS may receive the uplink data from the UE on part of the second resource or on the second resource (S14040).

In this case, the first DCI and the second DCI may include at least one parameter for transmission of the uplink data as described in Embodiments 1 to 9.

Thereafter, the BS may receive part or all of the uplink data that has not been received from the UE due to resource preemption by another UE through the method described in Embodiments 1 to 9.

Through such a method, an effect that the BS flexibly allocates resource to the UE according to the requirements required by data is obtained.

In this regard, the operation of the BS described above may be specifically implemented by the BS devices 1510 and 1610 shown in FIGS. 15 and 16 of the present disclosure. For example, the operation of the BS described above may be performed by the processors 1511 and 1611 and/or the RF units (or modules) 1513 and 1615.

Specifically, the processors 1511 and 1611 may control to transmit first DCI for allocation of the first resource to the UE through the RF units (or modules) 1513 and 1615.

Here, the first DCI may include a UL grant for allocation of the first resource and may include the HARQ entity described in Embodiments 1 to 9.

Thereafter, the processors 1511 and 1611 may determine whether resource allocation to another UE is required for transmission and reception of emergency data requiring specific conditions (e.g., low delay and/or high reliability, etc.).

If there is no need to allocate a separate resource to another UE, the processors 1511 and 1611 may control the RF units (or modules) 1513 and 1615 to receive first uplink data on the first resource allocated to the UE based on the first DCI.

However, if separate resource allocation to another UE is required, the processors 1511 and 1611 may control to allocate part or all of the first resource allocated to the UE to the other UE.

Thereafter, the processors 1511 and 1611 may control the RF units (or modules) 1513 and 1615 to sequentially transmit the second DCI for allocation of the second resource to the UE after the first DCI transmission.

Here, the second DCI may include the HARQ entity in the same manner as the first DCI as described in Embodiments 1 to 9, and include an indicator indicating whether part or all of the first resource are preempted for data transmission/reception of a specific service (e.g., URLLC, etc.) requiring low delay and/or high reliability.

In addition, the processors 1511 and 1611 may inform about whether all of part of the first resource is preempted by another UE through the second DCI or the second resource as in the method described in Embodiments 1 to 9 through the RF units (or modules) 1513 and 1615.

For example, when part or all of the first resource and the second resource overlap, the UE may recognize that partial resource or the first resource has been preempted by another UE.

When part or all of the first resource and the second resource overlap, the processors 1511 and 1611 may control the RF units (or modules) 1513 and 1615 to receive the uplink data from the UE on part of the second resource or on the second resource.

In this case, the first DCI and the second DCI may include at least one parameter for transmission of the uplink data as described in Embodiments 1 to 9.

Thereafter, the processors 1511 and 1611 may control the RF units (or modules) 1513 and 1615 to receive again part or all of the uplink data that has not been received from the UE due to resource preemption by the other UE again through the method described in Embodiments 1 to 9.

Through such a method, an effect that the BS may flexibly allocate resource to the UE according to the requirements required by data is obtained.

Overview of Devices to which Present Disclosure is Applicable

FIG. 15 illustrates a block diagram of a wireless communication device to which methods proposed by this specification may be applied.

Referring to FIG. 15, a wireless communication system includes an eNB 1510 and multiple user equipments 1520 positioned within an area of the eNB.

Each of the eNB and the UE may be expressed as a wireless device.

The eNB includes a processor 1511, a memory 1512, and a radio frequency (RF) module 1513. The processor 1511 implements a function, a process, and/or a method which are proposed in FIGS. 1 to 14 above. Layers of a radio interface protocol may be implemented by the processor. The memory is connected with the processor to store various information for driving the processor. The RF unit (1513) is connected with the processor to transmit and/or receive a radio signal.

The UE includes a processor 1521, a memory 1522, and an RF unit 1523.

The processor implements a function, a process, and/or a method which are proposed in FIGS. 1 to 14 above. Layers of a radio interface protocol may be implemented by the processor. The memory is connected with the processor to store various information for driving the processor. The RF unit 1523 is connected with the processor to transmit and/or receive a radio signal.

The memories 1512 and 1522 may be positioned inside or outside the processors 1511 and 1521 and connected with the processor by various well-known means.

Further, the eNB and/or the UE may have a single antenna or multiple antennas.

FIG. 16 illustrates another example of the block diagram of the wireless communication device to which the methods proposed in this disclosure may be applied.

Referring to FIG. 16, a wireless communication system includes an eNB 1610 and multiple user equipments 1620 positioned within an area of the eNB. The eNB may be represented by a transmitting apparatus and the UE may be represented by a receiving apparatus, or vice versa. The eNB and the UE include processors (1611,1621), memories (1614,1624), one or more Tx/Rx radio frequency (RF) modules (1615,1625), Tx processors (1612,1622), Rx processors (1613, 1623) and antennas (1616, 1626). The processor implements a function, a process, and/or a method which are described above. More specifically, a higher layer packet from a core network is provided to the processor 1611 in DL (communication from the eNB to the UE). The processor implements a function of an L2 layer. In the DL, the processor provides multiplexing between a logical channel and a transmission channel and allocation of radio resources to the UE 1620, and takes charge of signaling to the UE. The transmit (TX) processor 1612 implement various signal processing functions for an L1 layer (i.e., physical layer). The signal processing functions facilitate forward error correction (FEC) at the UE and include coding and interleaving. Encoded and modulated symbols are divided into parallel streams, each stream is mapped to an OFDM subcarrier, multiplexed with a reference signal (RS) in a time and/or frequency domain, and combined together by using inverse fast Fourier transform (IFFT) to create a physical channel carrying a time domain OFDMA symbol stream. An OFDM stream is spatially precoded in order to create multiple spatial streams. Respective spatial streams may be provided to different antennas 1616 via individual Tx/Rx modules (or transceivers, 1615). Each Tx/Rx module may modulate an RF carrier into each spatial stream for transmission. In the UE, each Tx/Rx module (or transceiver, 1625) receives a signal through each antenna 1626 of each Tx/Rx module. Each Tx/Rx module reconstructs information modulated with the RF carrier and provides the reconstructed information to the receive (RX) processor 1623. The RX processor implements various signal processing functions of layer 1. The RX processor may perform spatial processing on information in order to reconstruct an arbitrary spatial stream which is directed for the UE. When multiple spatial streams are directed to the UE, the multiple spatial streams may be combined into a single OFDMA symbol stream by multiple RX processors. The RX processor transforms the OFDMA symbol stream from the time domain to the frequency domain by using fast Fourier transform (FFT). A frequency domain signal includes individual OFDMA symbol streams for respective subcarriers of the OFDM signal. Symbols on the respective subcarriers and the reference signal are reconstructed and demodulated by determining most likely signal arrangement points transmitted by the eNB. The soft decisions may be based on channel estimation values. The soft decisions are decoded and deinterleaved to reconstruct data and control signals originally transmitted by the eNB on the physical channel. The corresponding data and control signals are provided to the processor 1621.

UL (communication from the UE to the eNB) is processed by the eNB 1610 in a scheme similar to a scheme described in association with a receiver function in the UE 1620. Each Tx/Rx module 1625 receives the signal through each antenna 1626.

Each Tx/Rx module provides the RF carrier and information to the RX processor 1623. The processor 1621 may be associated with the memory 1624 storing a program code and data. The memory may be referred to as a computer readable medium.

The embodiments described above are implemented by combinations of components and features of the disclosure in predetermined forms. Each component or feature should be considered selectively unless specified separately. Each component or feature may be carried out without being combined with another component or feature. Moreover, some components and/or features are combined with each other and may implement embodiments of the disclosure. The order of operations described in embodiments of the disclosure may be changed. Some components or features of one embodiment may be included in another embodiment, or may be replaced by corresponding components or features of another embodiment. It is apparent that some claims referring to a specific claim may be combined with another claim referring to the claims other than the specific claim to constitute the embodiment or add new claims by means of amendment after the application is filed.

Embodiments of the disclosure may be implemented by various means, for example, hardware, firmware, software, or combinations thereof. When embodiments are implemented by hardware, one embodiment of the disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

When embodiments are implemented by firmware or software, one embodiment of the disclosure may be implemented by modules, procedures, functions, etc. Performing functions or operations described above. Software code may be stored in a memory and may be driven by a processor. The memory is provided inside or outside the processor and may exchange data with the processor by various well-known means.

It is apparent to those skilled in the art that the disclosure may be embodied in other specific forms without departing from essential features of the disclosure. Accordingly, the aforementioned detailed description should not be construed as limiting in all aspects and should be considered as illustrative. The scope of the disclosure should be determined by rational construing of the appended claims, and all modifications within an equivalent scope of the disclosure are included in the scope of the disclosure.

### INDUSTRIAL APPLICABILITY

The example applied to the 3GPP LTE/LTE-A/NR system has been mainly described but the present disclosure may be applied to various wireless communication systems in addition to the 3GPP LTE/LTE-A/NR system.

1. A method for transmitting uplink data by a user equipment (UE) in a wireless communication system, the method comprising:
sequentially receiving, from a base station (BS), first downlink control information (DCI) for allocation of a first resource and second DCI for allocation of a second resource; and
when the first resource and a partial resource of the second resource overlap each other, transmitting, to the BS, the uplink data on part of the second resource or on the second resource,
wherein the first DCI and the second DCI include at least one parameter for transmission of the uplink data.

2. The method of claim 1, wherein the first resource includes a resource region preempted for transmission of uplink data of another UE.

3. The method of claim 2, wherein the preempted resource region is a resource region for transmission or reception of data requiring delay lower than delay of the uplink data.

4. The method of claim 2, wherein the preempted resource region is dropped, punctured, rate-matched, or canceled.

5. The method of claim 4, further comprising:
being allocated, from the BS, a third resource region for re-transmission of data matched to the preempted resource region in the uplink data; and
transmitting, to the BS, the data according to priority in the third resource region.

6. The method of claim 5, wherein
the priority is determined based on at least one of uplink control information (UCI) type and/or service type of the data.

7. The method of claim 1, wherein
the uplink data is transmitted based on the second DCI.

8. The method of claim 1, wherein
a transport block (TB) for transmission of the uplink data is mapped to the partial resource or the second resource and transmitted.

9. The method of claim 1, wherein
an HARQ ID of the first DCI and an HARQ ID of the second DCI are the same.

10. The method of claim 1, wherein
when a time obtained by subtracting a starting timing of the second resource from a starting timing of the first resource is smaller than a time obtained by adding a timing advance (TA) to a processing time of the second DCI, a resource from the starting timing of the first resource to the time obtained by adding the TA to the processing time of the second DCI is used for transmission of the uplink data.

11. The method of claim 1, wherein
a size of a transport block based on the first DCI is the same as a size of a transport block based on the second DCI.

12. A method for receiving uplink data by a base station (BS) in a wireless communication system, the method comprising:
sequentially transmitting, to a user equipment (UE), first downlink control information (DCI) for allocation of a first resource and second DCI for allocation of a second resource; and
when the first resource and a partial resource of the second resource overlap each other, receiving, from the UE, the uplink data on part of the second resource or on the second resource,
wherein the first DCI and the second DCI include at least one parameter for transmission of the uplink data.

13. A user equipment of transmitting uplink data in a wireless communication system, the user equipment comprising:
a radio frequency (RF) module for transmitting or receiving a wireless signal; and
a processor functionally connected to the RF module,
wherein the processor is configured to:
sequentially receive, from a base station (BS), first downlink control information (DCI) for allocation of a first resource and second DCI for allocation of a second resource; and
when the first resource and a partial resource of the second resource overlap each other, transmit, to the BS, the uplink data on part of the second resource or on the second resource,
wherein the first DCI and the second DCI include at least one parameter for transmission of the uplink data.
